(19) United States
(12) Patent Application Publication
(10) Pub. No.: US 2013/0216733 A1
(43) Pub. Date: Aug. 22, 2013

(54) OPTICAL FILM AND ITS PRODUCTION METHOD, POLARIZER AND LIQUID CRYSTAL DISPLAY DEVICE

(71) Applicant: FUJIFILM CORPORATION, (US)

(72) Inventors: Katsumi SASATA, Kanagawa (JP); Hajime NAKAYAMA, Kanagawa (JP)

(73) Assignee: FUJIFILM CORPORATION, Tokyo (JP)

(21) Appl. No.: 13/804,464

(22) Filed: Mar. 14, 2013

Related U.S. Application Data
(63) Continuation of application No. PCT/JP2011/073025, filed on Sep. 29, 2011.

(30) Foreign Application Priority Data
Sep. 29, 2010 (JP) 2010-219612
Jun. 30, 2011 (JP) 2011-146320

(51) Int. Cl. G02F 1/1335; G02B 5/30

(52) U.S. Cl. CPC G02F 1/133528; G02B 5/30; G02B 5/305
USPC 428/1.31; 264/1.34; 428/510; 428/216

(57) ABSTRACT

An optical film having an acrylic resin layer and a cellulose acylate layer, wherein the weight-average molecular weight of the acrylic resin used as the main ingredient in the acrylic resin layer is from 600,000 to 4,000,000, hardly causes display unevenness when it is incorporated in a liquid crystal display device.

### CROSS-REFERENCE TO RELATED APPLICATIONS

This application is a continuation application of International Application No. PCT/JP2011/073025, filed Sep. 29, 2011, which in turn claims the benefit of priority from Japanese Application No. 2010-219612, filed Sep. 29, 2010, and Japanese Application No. 2011-146320, filed Jun. 30, 2011, the disclosures of which Applications are incorporated by reference herein in their entirety.

### BACKGROUND OF THE INVENTION

1. Field of the Invention

The present invention relates to an optical film and its production method, a polarizer and a liquid crystal display device.

2. Description of the Related Art

As capable of saving power energy consumption and capable of being thin-walled, liquid crystal display devices are widely employed as image display devices such as TVs, personal computers, etc. The liquid crystal display device comprises a polarizer arranged on both sides of the liquid crystal cell therein, in which the polarizer comprises a polarizing film having iodine or dye adsorbed and aligned therein and sandwiched between transparent resin layers put on both sides thereof. In this, the transparent resin layers act to protect the polarizing element, for which a cellulose ester film is well used.

With the recent popularization of such liquid crystal display devices, much desired are further thin-walled, large-sized and high-performance devices.

A cellulose ester film has a high transmittance, and by dipping in an aqueous alkali solution, its surface is saponified and hydrophilicated to thereby realize excellent adhesiveness to a polarizing element. However, the film has a problem of dimensional change through moisture absorption and water removal in environmental temperature/humidity change. Another problem is that, when the cellulose ester film is incorporated in a liquid crystal display device and when the other constitutive parts of the device that have been deformed through aging degradation or the like therein are kept in contact with the film, display fluctuation often occurs; and the problem has become considered serious with the recent tendency toward advanced demand for body thickness reduction.

For solving the problems, there has been proposed an acrylic resin film having a small moisture absorption and having a small photoelastic coefficient, as a film that could be substitutable for the cellulose ester film; however, it could not be said that the adhesiveness of the film of the type to a polarizing element could be sufficient, and therefore there still remains a problem in that an acrylic single-layer film could hardly be adhered to a polarizing element.

In that situation, there has been proposed a technique of laminating these different types of films to solve the problems with the individual films (see JP-A 2001-215331).

JP-A 2001-215331 discloses a technique of producing a cellulose triacetate/acrylic resin laminate film according to a co-casting method. For example, in Examples in the patent publication, described is a configuration of cellulose triacetate film/acrylic resin film/cellulose triacetate film. However, the acrylic resin used in Examples in the patent publication is not specifically identified as a material.

On the other hand, as the acrylic resin, one having a molecular weight of 100,000 or so is generally used for film formation. Precisely, it is naturally impossible to form a high-molecular-weight acrylic resin film according to a melt casting method. An acrylic resin film may be formed according to a solution casting method, but in such a case, a dope having a viscosity suitable for solution casting must be prepared.

Heretofore, an acrylic resin having a molecular weight of 300,000 or so can form a dope highly suitable for casting film formation, and the acrylic resin of the type has heretofore been used in film formation.

### SUMMARY OF THE INVENTION

The dope composition in Examples in JP-A 2001-215331 is merely such that, when an acrylic resin having a molecular weight of 300,000 or so therein, the composition could have a good aptitude for ordinary solution casting film formation; and the present inventors have tried the method described in JP-A 2001-215331, using the above-mentioned ordinary acrylic resin, but have found that there occurs another problem in point of the film surface condition, especially in that the laminate film surface is roughened.

An object of the invention is to provide an optical film comprising a cellulose ester film, which, when the optical film is incorporated in a liquid crystal display device and when the other constitutive parts in the device are kept in contact with the cellulose ester film, hardly causes display unevenness and which is therefore easy to adhere to a polarizing element and has a good film surface condition.

For solving the above-mentioned problem, the inventors have assiduously studied and, as a result, have found that, in case where an acrylic resin and a cellulose ester resin are co-cast to form an acrylic resin/cellulose ester resin laminate film, when the combination between the concentration and the viscosity of the dope is suitably defined, then the surface condition of the laminate film can be dramatically improved. The inventors have further found that, for suitably defining the relationship between the dope concentration and viscosity, an acrylic resin having a much higher molecular weight than the ordinary acrylic resin generally used in formation of optical film must be indispensably used. Based on these findings, the inventors have completed the present invention.

The following constitution can solve the above-mentioned problem.

[1] An optical film having an acrylic resin layer containing an acrylic resin, and, as formed on the surface of the acrylic resin layer, at least one cellulose acylate layer containing a cellulose acylate, wherein the weight-average molecular weight of the acrylic resin used as the main ingredient in the acrylic resin layer is from 600,000 to 4,000,000.
[2] The optical film of [1], wherein the weight-average molecular weight of the cellulose acylate used as the main ingredient in the cellulose acylate layer is from 50,000 to 500,000.
[3] The optical film of [1] or [2], wherein the thickness of the acrylic resin layer is from 20 to 60 μm, and the thickness of every cellulose acylate layer is from 1 to 10 μm.
[4] The optical film of any one of [1] to [3], wherein the proportion of the total thickness of the cellulose acylate layer to the overall film thickness is at most 40%.
[5] The optical film of any one of [1] to [4], wherein the degree of substitution with the acyl group in the cellulose acylate is from 1.2 to 3.0.
[6] The optical film of any one of [1] to [5], wherein the weight-average molecular weight of the acrylic resin used as the main ingredient in the acrylic resin layer is from 1,000,000 to 1,800,000.
[7] The optical film of any one of [1] to [6], which has a photoelastic coefficient of from −5.0 to 5.0×10⁻¹² Pa⁻¹.
[8] The optical film of any one of [1] to [7], wherein the in-plane retardation Re defined by the following formula (I) and the thickness-direction retardation Rth defined by the following formula (II) satisfy the following formula (III) and the following formula (IV) in an environment at 25° C. and at a relative humidity of 60%, and wherein the absolute value of the difference between the value Rth measured in an environment at 25° C. and at a relative humidity of 10% and the value Rth measured in an environment at 25° C. and at a relative humidity of 80% is at most 10 nm:

Re=(nx−ny)×d (I)

Rth={(nx+ny)/2−nz}×d (II)

|Re|<10 nm (III)

|Rth|<25 nm (IV)

wherein nx means the in-plane refractive index of the film in the slow axis direction; ny means the in-plane refractive index of the film in the fast axis direction; nz means the refractive index of the film in the thickness direction; d means the film thickness (nm).
[9] The optical film of any one of [1] to [8], wherein the cellulose acylate layer is provided on both surfaces of the acrylic resin layer.
[10] A method for producing an optical film comprising casting at least two types of dopes (A) and (B) each containing a thermoplastic resin and an organic solvent onto a casting substrate simultaneously or successively in the order of (A)-(B)-(A) from the casting substrate side, and removing the organic solvent, wherein the dope (A) contains a cellulose acylate and the dope (B) contains an acrylic resin having a weight-average molecular weight of from 600,000 to 4,000,000.
[11] The method for producing an optical film of [10], wherein the weight-average molecular weight of the cellulose acylate contained in the dope (A) is from 50,000 to 500,000.
[12] The method for producing an optical film of [10] or [11], wherein the solid concentration of the dope (A) and the dope (B) each is from 16 to 30% by mass.
[13] The method for producing an optical film of any one of [10] to [12], wherein the absolute value of the difference between the solid concentration of the dope (A) and that of the dope (B) is at most 10% by mass.
[14] The method for producing an optical film of any one of [10] to [13], wherein the complex viscosity of the dope (A) and the dope (B) each is from 10 to 80 Pa·s and the complex viscosity of the dope (B) is larger than the complex viscosity of the dope (A).
[15] The method for producing an optical film of any one of [10] to [14], wherein in the organic solvent contained in the dope (A) and the dope (B), the proportion of methanol to the entire organic solvent in the dope is from 20 to 35% by mass.
[16] An optical film produced according to the optical film production method of any one of [10] to [15].
[17] A polarizer comprising a polarizing element and the optical film of any one of [1] to [9] and [16].
[18] A liquid crystal display device comprising the optical film of anyone of [1] to [9] and [16] or the polarizer of [17].

According to the invention, there can be provided an optical film comprising a cellulose ester film, which, when the optical film is incorporated in a liquid crystal display device and when the other constitutive parts in the device are kept in contact with the cellulose ester film, hardly causes display unevenness and which is therefore easy to adhere to a polarizing element and has a good film surface condition; and a method for producing the optical film.

### BRIEF DESCRIPTION OF DRAWING

FIG. 1 is a graphical view showing one example of a drum casting apparatus. In FIG. 1, 101 is casting apparatus, 102 is drum, 14 is casting die, 12 is dope, PS is casting start point, 105 is condenser plate, 53 is liquid receiver, 56 is collector tank, 36 is film and 37 is peeling roller.

### MODES FOR CARRYING OUT THE INVENTION

Embodiments of carrying out the invention are described in detail hereinunder, however, the invention should not be limited to these. In this description, when a numerical value indicates a physical value, a characteristic value or the like, the numerical range expressed by the wording “(numerical value 1) to (numerical value 2)” means the range that falls “from the (numerical value 1) or more to the (numerical value 2) or less”. (Meth)acryl means methacryl or acryl; and (meth)acryloyl means methacryloyl or acryloyl. In this description, the wording “as the main ingredient” means that the amount of the ingredient is at least 50% by mass. For example, the main ingredient of the cellulose acylate contained in the cellulose acylate layer means the cellulose acylate that accounts for at least 50% by mass of the cellulose acylate contained in the cellulose acylate layer.

### [Optical Film]

The optical film of the invention (hereinafter this may be referred to as the film of the invention) has an acrylic resin layer containing an acrylic resin, and, as formed on the surface of the acrylic resin layer, at least one cellulose acylate layer containing a cellulose acylate, wherein the weight-average molecular weight of the acrylic resin used as the main ingredient in the acrylic resin layer is from 600,000 to 4,000,000.

In the film of the invention, such an acrylic resin having a molecular weight of from 600,000 to 4,000,000, which is much larger than that of the acrylic resin heretofore used in the field of optical film, is used, and therefore the film surface condition of the laminate film can be greatly improved.

In addition, the cellulose acylate layer may be formed on one surface of the acrylic layer, but preferably formed on both surfaces thereof for the purpose of well controlling the physical properties and the behavior to environmental change of the film.

Preferred embodiments of the film of the invention are described below.

### <Film Configuration and Characteristics>

### (Ratio of Cellulose Acylate Layer and Acrylic Resin Layer)

In the film of the invention, preferably, the thickness of the acrylic resin layer is from 20 to 60 μm, and the thickness of every cellulose acylate layer is from 1 to 10 μm. Also preferably, the thickness of one cellulose acylate layer is from 1 to 10 μm, more preferably from 1 to 8 μm, even more preferably from 1 to 5 μm. Also preferably, the thickness of the acrylic resin layer is from 20 to 60 μm, more preferably from 25 to 50 μm, even more preferably from 25 to 40 μm.

The overall thickness of the entire optical film as a laminate is preferably from 11 to 240 μm, more preferably from 15 to 150 μm, most preferably from 20 to 100 μm, still more preferably from 20 to 50 μm.

Also preferably, the proportion of the total thickness of the cellulose acylate layer to the overall film thickness of the film is at most 40%, more preferably from 1 to 30%, even more preferably from 5 to 20%. The total thickness of the cellulose acylate layer as referred to herein means the total thickness of two cellulose acylate layers, if any, in the film.

When these requirements are satisfied, the surface condition of the cast film may be more bettered. In addition, the interfacial adhesiveness and the curling resistance of the optical film may be bettered and the water absorption thereof may be lowered.

### (Film Surface Condition)

The film of the invention is characterized in that the maximum difference between the largest thickness and the smallest thickness thereof (P-V value) is small.

The maximum difference between the largest thickness and the smallest thickness of the film (P-V value) may be measured according to a known method, for example, using a fringe analyzer, a laser displacement meter, a contact film thickness gauge, etc.

In the method of using a fringe analyzer, for example, a fringe analyzer, FUJINON FX-03 can be used for the measurement. In the other method than the method of using a fringe analyzer, for example, the film thickness within a range of a circle drawn around a center point in the film and having a diameter of 60 mm may be measured using a laser displacement meter, a contact film thickness gauge or the like, and from the found data, the maximum difference between the largest thickness and the smallest thickness of the film may be computed.

Preferably, the maximum difference between the largest thickness and the smallest thickness (P-V value) of the film of the invention is at most 3.0 μm, more preferably at most 1.1 μm, even more preferably at most 0.9 μm.

### (Retardation)

In this description, Re(λ) and Rth(λ) each mean the in-plane retardation and the thickness-direction retardation of the film at a wavelength of λ. In this description, the wavelength λ is 550 nm unless otherwise specifically indicated. Re(λ) is measured by applying a light having a wavelength of λ nm in the normal direction of the film, using KOBRA-21ADH or WR (by Oji Scientific Instruments). In selecting the measurement wavelength λ nm, a wavelength selection filter may be exchanged by manual, or the measured data may be converted according to the corresponding program or the like.

When the film to be analyzed is represented by a monoaxial or biaxial index ellipsoid, then its Rth(λ) may be computed according to the method mentioned below.

Rth(λ) is determined as follows: With the in-plane slow axis (determined by KOBRA 21ADH or WR) taken as the tilt axis (rotation axis) of the film (in case where the film has no slow axis, the rotation axis of the film may be in any in-plane direction of the film), Re(λ) of the film is measured at 6 points in all thereof, from the normal direction of the film up to 50 degrees on one side relative to the normal direction thereof at intervals of 10°, by applying a light having a wavelength of λ nm from the tilted direction of the film. Based on the thus-determined retardation data of Re(λ), the assumptive mean refractive index and the inputted film thickness, Rth(λ) of the film is computed with KOBRA 21ADH or WR.

In the above, with the in-plane slow axis from the normal direction taken as the rotation axis thereof, when the film has a zero retardation value at a certain tilt angle, then the symbol of the retardation value of the film at a tilt angle larger than that tilt angle is changed to a negative one, and then applied to KOBRA 21ADH or WR for computation.

With the slow axis taken as the tilt axis (rotation axis) (in case where the film has no slow axis, the rotation axis of the film may be in any in-plane direction of the film), the retardation values of the film are measured in any tilted two directions; and based on the data, the assumptive mean refractive index and the inputted film thickness, Rth may be computed according to the following formulae (11) and (12):

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad ( 11 )$$

wherein Re(θ) means the retardation value of the film in the direction titled by an angle θ from the normal direction.

In the formula (11), nx means the in-plane refractive index of the film in the slow axis direction; ny means the in-plane refractive index of the film in the direction vertical to nx; nz means the refractive index of the film vertical to nx and ny; and d means the film thickness.

Rth=((nx+ny)/2−nz)×d. (12)

When the film to be analyzed could not be represented by a monoaxial or biaxial index ellipsoid, or that is, when the film does not have an optical axis, then its Rth(λ) may be computed according to the method mentioned below.

With the in-plane slow axis (determined by KOBRA 21ADH or WR) taken as the tilt axis (rotation axis) of the film, Re(λ) of the film is measured at 11 points in all thereof, from −50° to +50° relative to the normal direction of the film at intervals of 10°, by applying a light having a wavelength of λ nm from the tilted direction of the film. Based on the thus-determined retardation data Re(λ), the assumptive mean refractive index and the inputted film thickness, Rth(λ) of the film is computed with KOBRA 21ADH or WR.

In this, for the assumptive mean refractive index, referred to are the data in Polymer Handbook (John Wiley & Sons, Inc.) or the data in the catalogues of various optical films. Films of which the mean refractive index is unknown may be analyzed with an Abbe's refractiometer to measure the mean refractive index thereof. Data of the mean refractive index of some typical optical films are mentioned below. Cellulose acylate (1.48), cycloolefin polymer (1.52), polycarbonate (1.59), polymethyl methacrylate (1.49), polystyrene (1.59). With the assumptive mean refractive index and the film thickness inputted thereinto, Kobra 21ADH or WR can compute nx, ny and nz. From the thus-computed data nx, ny and nz, Nz=(nx−nz)/(nx−ny) is induced.

Preferably in the film of the invention, the in-plane retardation Re defined by the following formula (I) and the thickness-direction retardation Rth defined by the following formula (II) satisfy the following formula (III) and the following formula (IV) in an environment at 25° C. and at a relative humidity of 60%, and the absolute value of the difference between the value Rth measured in an environment at 25° C. and at a relative humidity of 10% and the value Rth measured in an environment at 25° C. and at a relative humidity of 80% is at most 10 nm:

Re=(nx−ny)×d (I)

Rth={(nx+ny)/2−nz}×d (II)

|Re|<10 nm (III)

|Rth|<25 nm (IV)

wherein nx means the in-plane refractive index of the film in the slow axis direction; ny means the in-plane refractive index of the film in the fast axis direction; nz means the refractive index of the film in the thickness direction; d means the film thickness (nm).

Preferably, the film of the invention satisfies |Re|<10 nm, more preferably |Re|≦5 nm, even more preferably |Re|≦2 nm.

Also preferably, the film of the invention satisfies |Rth|<25 nm, more preferably |Rth|≦15 nm, even more preferably |Rth|≦10 nm.

### (Humidity Dependence of Rth)

In the film of the invention, the humidity dependence of Rth (ΔRth=Rth(10%)−Rth(80%)) is preferably at most 10 nm, more preferably less than 8 nm, even more preferably less than 5 nm, still more preferably less than 3 nm.

In the invention, the humidity dependence of Re (ΔRe) and the humidity dependence of Rth (ΔRth) are computed according to the following formulae, based on the in-plane and thickness-direction retardation values at a relative humidity of H (unit, %), Re(H%) and Rth(H%):

ΔRe=Re(10%)−Re(80%)[nm]

ΔRth=Rth(10%)−Rth(80%)[nm]

Re(H%) and Rth(H%) are the retardation values of the film that has been conditioned at 25° C. and at a relative humidity of H% for 24 hours, and the values thereof are measured and computed according to the same methods as above, at 25° C. and at a relative humidity of H% and at a measurement wavelength of 590 nm. A mere expression Re with no indication relating to the relative humidity means the value of retardation measured at a relative humidity of 60%.

More preferably, the retardation values of the optical film as measured at different humidity satisfy the following relational formulae.

|ΔRe|<8 nm, and |ΔRth|<8 nm;

even more preferably,

|ΔRe|<5 nm, and |ΔRth|<5 nm;

still more preferably,

|ΔRe|<3 nm, and |ΔRth|<3 nm.

Controlling the retardation values of the film at different humidity in the manner as above makes it possible to reduce the retardation change of the film in varying external environments and therefore makes it possible to provide high-reliability liquid crystal display devices comprising the film.

Reducing the ΔRth of the optical film of the invention may bring about a favorable effect that, when the film is incorporated in a liquid crystal display device, a problem of circular color unevenness (display unevenness) that may be seen in watching the device obliquely on the display panel thereof under a specific condition could be solved.

### (Photoelastic Coefficient)

Preferably, the absolute value of the photoelastic coefficient of the film of the invention is at most 5.0×10⁻¹² Pa⁻¹, more preferably at most 3×10⁻¹² Pa⁻¹, even more preferably at most 1×10⁻¹² Pa⁻¹. The photoelastic coefficient is the property inherent in a substance; and rather few substances could express the photoelastic coefficient thereof. For example, most polymer resins express birefringence owing to external stress or thermal stress given thereto. The sign of the photoelastic coefficient may be defined in relation to the direction of the applied stress. Specifically, in case where a tensile stress is given to a medium (polymer resin), the sign of the photoelastic coefficient of the medium can be expressed as plus or minus of the photoelastic coefficient c represented by the following formula (I), relative to the refractive index nₚₐᵣₐ to the polarized light having a polarization plane in the direction parallel to the tensile stress, and the refractive index nₚₑᵣₚ to the polarized light having a polarization plane in the direction perpendicular to that parallel direction.

c=Δn/σ=(nₚₐᵣₐ−nₚₑᵣₚ)/σ (1)

In other words, in case where nₚₐᵣₐ is larger than nₚₑᵣₚ, the photoelastic coefficient is plus, but in case where the former is smaller than the latter, the photoelastic coefficient is minus. When the photoelastic coefficient of the film of the invention falls within a range of from −5.0×10⁻¹² to 5.0×10⁻¹² Pa⁻¹, it is favorable since the liquid crystal display device comprising the film may be free from a problem of display unevenness. In particular, in case where the film of the invention is stretched and then incorporated in a liquid crystal display device, it is especially desirable that the photoelastic coefficient of the film falls within the above range.

### (Film Width)

Preferably, the width of the film of the invention is from 400 to 2500 mm, more preferably at least 1000 mm, even more preferably at least 1500 mm, still more preferably at least 1800 mm.

### <Acrylic Resin Layer>

The film of the invention has an acrylic resin layer containing an acrylic resin, in which the weight-average molecular weight of the acrylic resin to be used as the main ingredient of the acrylic resin layer is from 600,000 to 4,000,000.

### (Acrylic Resin)

The acrylic resin for use in the invention includes a methacrylic resin, for which well known are acrylate/methacrylate derivatives, especially acrylate/methacrylate (co)polymers. Not specifically defined, the acrylic resin preferably comprises from 50 to 99% by mass of a methyl methacrylate unit and from 1 to 50% by mass of any other monomer unit copolymerizable with the methyl methacrylate unit, from the viewpoint of obtaining a film having a small photoelastic coefficient.

In the acrylic resin, the other copolymerizable monomer includes alkyl methacrylates in which the alkyl group has from 2 to 18 carbon atoms, alkyl acrylates in which the alkyl group has from 1 to 18 carbon atoms; α,β-unsaturated acids such as acrylic acid, methacrylic acid, etc.; unsaturated group-containing dicarboxylic acids such as maleic acid, fumaric acid, itaconic acid, etc.; aromatic vinyl compounds such as styrene, α-methylstyrene, etc.; α,β-unsaturated nitriles such as acrylonitrile, methacrylonitrile, etc.; maleic anhydride, maleimide, N-substituted maleimides, glutaric anhydride, etc. One alone or two or more of these monomers may be used as the copolymerization component, either singly or as combined.

Of those, preferred are methyl acrylate, ethyl acrylate, n-propyl acrylate, n-butyl acrylate, s-butyl acrylate, 2-ethylhexyl acrylate, etc., from the viewpoint of the thermal decomposition resistance and the flowability of the copolymers; and more preferred are methyl acrylate and n-butyl acrylate.

As the resin capable of forming an optical film, of which the performance change is small even in high-temperature and high-humidity environments and which is highly transparent, preferred is an acrylic resin preferably has an alicyclic alkyl group as the copolymerization component thereof, or an acrylic resin of which the main chain of the molecule has a cyclic structure formed through intramolecular cyclization. One preferred embodiment of the acrylic resin of which the main chain of the molecule has a cyclic structure formed through intramolecular cyclization is an acrylic thermoplastic resin including a lactone ring-containing polymer; and the preferred resin composition and the preferred production method are described in JP-A 2006-171464. Another preferred embodiment is a resin containing glutaric anhydride as the copolymerization component thereof; and the copolymerization component and the concrete production method are described in JP-A 2004-070296.

### (Weight-Average Molecular Weight of Acrylic Resin)

In the film of the invention, the weight-average molecular weight of the acrylic resin used as the main ingredient in the acrylic resin layer is from 600,000 to 4,000,000, preferably from 800,000 to 3,000,000, more preferably from 1,000,000 to 1,800,000.

The weight-average molecular weight of the acrylic resin may be measured through gel permeation chromatography.

Preferably, the molecular weight of the acrylic resin does not lower during the process of producing the film of the invention. For example, in the process of producing the film of the invention, the film may be heated in the step of drying the film for removing the solvent therefrom. In this step, the acrylic resin may be thermally decomposed and the molecular weight thereof may be lowered. Concretely, in case where the molecular weight of the acrylic resin before film formation is 100, it is desirable that the molecular weight of the acrylic resin in the film of the invention after film formation is larger than 60, more preferably larger than 75, even more preferably larger than 90.

The production method for the acrylic resin is not specifically defined, for which is employable any known method of suspension polymerization, emulsion polymerization, bulk polymerization, solution polymerization or the like.

Two or more different types of acrylic resins may be used here as combined.

(Other Thermoplastic Resin Capable of being Combined with Acrylic Resin)

The acrylic resin may contain any other thermoplastic resin. The thermoplastic resin usable in the invention is preferably one having a glass transition temperature of not lower than 100° C. and a total light transmittance of at least 85%, as capable of enhancing the heat resistance and the mechanical strength of the film formed of it combined with the acrylic resin.

Regarding the content of the acrylic resin and the other thermoplastic resin in the acrylic resin layer, the ratio by mass of [acrylic resin/(total thermoplastic resin)]×100 is preferably from 30 to 99% by mass, more preferably from 50 to 97% by mass, even more preferably from 60 to 95% by mass. When the content of the acrylic resin in the acrylic resin layer is at least 30% by mass, it is favorable since the resin can sufficiently exhibit heat resistance.

The other thermoplastic resin includes, for example, olefinic polymers such as polyethylene, polypropylene, ethylene/propylene copolymer, poly(4-methyl-1-pentene), etc.; halogenopolymers such as polyvinyl chloride, vinyl chloride resin, etc.; styrenic polymers such as polystyrene, styrene-methyl methacrylate copolymer, styrene/acrylonitrile copolymer, acrylonitrile/butadiene/styrene block copolymer, etc.; polyesters such as polyethylene terephthalate, polybutylene terephthalate, polyethylene naphthalate, etc.; polyamides such as nylon 6, nylon 66, nylon 610, etc.; polyacetals; polycarbonates; polyphenylene oxides; polyphenylene sulfides; polyether ether ketones; polysulfones; polyether sulfones; polyoxybenzylenes; polyamidimides; rubbery polymers such as ABS resins or ASA resins mixed with polybutadiene rubber, acrylic rubber, etc. The rubbery polymer preferably has a graft moiety having a composition miscible with the cyclic polymer in the invention, in the surface thereof, and more preferably the mean particle size of the rubbery polymer is at most 100 nm, even more preferably at most 70 nm from the viewpoint of increasing the transparency of the formed film.

Preferably, the other thermoplastic resin is thermodynamically miscible with the acrylic resin. As the other thermoplastic resin of the type, preferred are an acrylonitrile/styrene copolymer having a vinyl cyanide monomer unit and an aromatic vinyl monomer unit, and a polyvinyl chloride resin, etc. Of those, more preferred is an acrylonitrile/styrene copolymer as capable of readily producing an optical film having a glass transition temperature of not lower than 120° C., an in-plane retardation per 100 μm of at most 20 nm and a total light transmittance of at least 85%.

As the acrylonitrile/styrene copolymer, concretely, one having a copolymerization ratio by mol of from 1/10 to 10/1 is advantageously used here.

### (Cellulose Acylate Layer>

The film of the invention has at least one cellulose acylate layer containing a cellulose acylate, as formed on the surface of the above-mentioned acrylic layer therein.

### (Type of Cellulose Acylate)

The cellulose acylate for use in the invention is not specifically defined. The starting cellulose includes cotton linter and wood pulp (hardwood pulp, softwood pulp), etc.; and any cellulose acylate obtained from any starting cellulose can be used herein. As the case may be, different starting celluloses may be mixed for use herein. The starting cellulose materials are described in detail, for example, in Marusawa & Uda's “Plastic Material Lecture (17), Cellulosic Resin” (by Nikkan Kogyo Shinbun, 1970), and in Hatsumei Kyokai Disclosure Bulletin No. 2001-1745, pp. 7-8.

### (Degree of Acyl Substitution of Cellulose Acylate)

Preferably, the cellulose acylate for use in the invention has a total degree of substitution with acyl group of from 1.2 to 3.0.

Preferably, the cellulose acylate for use in the invention satisfies the following conditions where TA-Total means the total degree of substitution with acyl group, TA2 means the degree of substitution with acyl group having 2 carbon atoms, and TA3 means the degree of substitution with acyl group having from 3 to 7 carbon atoms. Satisfying the following conditions, there can be obtained an optical film excellent in point of the adhesiveness thereof to neighboring layers, the drum releasability thereof, and the curling resistance thereof.

2.2≦TA−Total≦3.0

1.5≦TA2≦3.0

0.0≦TA3≦0.7

More preferably, the cellulose acylate satisfies the following conditions:

2.5≦TA−Total≦3.0

2.4≦TA2≦3.0

0.0≦TA3≦0.1

Especially preferably, the cellulose acylate for use in the invention is at least one selected from cellulose acetate, cellulose acetate propionate, cellulose acetate butyrate, cellulose acetate benzoate, cellulose propionate, cellulose butyrate. Of those, more preferred as the cellulose acylate are cellulose acetate and cellulose acetate propionate; and even more preferred is triacetyl cellulose.

The degree of substitution with acetyl group and the degree of substitution with other acyl group may be determined according to the method defined in ASTM-D817-96.

### (Weight-Average Molecular Weight of Cellulose Acylate)

Regarding the weight-average molecular weight (Mw) of the cellulose acylate for use in the invention, the weight-average molecular weight of the cellulose acylate for use as the main ingredient in the cellulose acylate layer is preferably from 50,000 to 500,000 from the viewpoint of bettering the film surface condition, more preferably from 80,000 to 400,000, even more preferably from 100,000 to 300,000.

On the other hand, the weight-average molecular weight of the cellulose acylate for use in the invention is more preferably from 75,000 to 300,000 from the viewpoint of the adhesiveness thereof to acrylic resin, even more preferably from 100,000 to 240,000, still more preferably from 160,000 to 240,000. When the weight-average molecular weight (Mw) of the cellulose acylate is at least 75,000, then it is favorable since the self-film formability of the cellulose acylate layer is bettered and the layer can exhibit improved adhesiveness. In the invention, two or more different types of cellulose acylates may be combined and used.

### <Additive>

The optical film of the invention may contain additives in the acrylic resin layer and the cellulose ester layer, along with one or more thermoplastic resins to be the main ingredient in these layers.

### (Plasticizer)

Preferably, a plasticizer is added to the optical film of the invention for the purpose of imparting softness to the film, improving the dimensional stability of the film and improving the moisture resistance thereof.

Preferably, the plasticizer for use in the invention contains a resin component having a molecular weight of from 500 to 100,000. For example, there may be mentioned the above-mentioned acrylic resin, polyester and polyether described in JP-A 2002-22956, polyester ether, polyester urethane and polyester described in JP-A 5-197073, copolyester ether described in JP-A 2-292342, epoxy resin and novolak resin described in JP-A 2002-146044, etc.

As the plasticizer excellent in evaporation resistance, bleeding-out resistance and haze reduction, for example, preferred for use herein are polyester diols having a hydroxyl group at both terminals, described in JP-A 2009-98674. As the plasticizer excellent in planarity and the low haze of the optical film containing it, preferred are sugar ester derivatives described in WO2009/031464.

### <<Polycondensate Ester>>

In the invention, a polycondensate ester is preferably used as the polymer plasticizer.

The polycondensate ester usable in the invention may be produced from at least one dicarboxylic acid selected from aliphatic dicarboxylic acids having from 2 to 20 carbon atoms and aromatic dicarboxylic acids having from 8 to 20 carbon atoms, and at least one diol selected from aliphatic diols having from 2 to 12 carbon atoms, alkyl ether diols having from 4 to 20 carbon atoms, and aromatic ring-containing diols having from 6 to 20 carbon atoms. For the production method, employable is any known method of dehydrating condensation of dicarboxylic acid and diol, or addition and dehydrating condensation of dicarboxylic anhydride to diol.

Dicarboxylic acids and diols preferably used in production of the polycondensate ester for use in the invention are described below.

As the dicarboxylic acid, any of aliphatic dicarboxylic acids and aromatic dicarboxylic acids is usable herein.

The aliphatic dicarboxylic acid includes, for example, oxalic acid, malonic acid, succinic acid, maleic acid, fumaric acid, glutaric acid, adipic acid, pimelic acid, suberic acid, sebacic acid, azelaic acid, undecanedicarboxylic acid, dodecanedicarboxylic acid, 1,4-cyclohexanedicarboxylic acid, etc. Above all, preferred are malonic acid, succinic acid, maleic acid, fumaric acid, glutaric acid, adipic acid, pimelic acid, suberic acid, sebacic acid, azelaic acid, undecanedicarboxylic acid, dodecanedicarboxylic acid, and 1,4-cyclohexanedicarboxylic acid.

The aromatic dicarboxylic acid includes phthalic acid, isophthalic acid, terephthalic acid, 1,4-xylylenedicarboxylic acid, 1,5-naphthalenedicarboxylic acid, 1,4-naphthalenedicarboxylic acid, 1,8-naphthalenedicarboxylic acid, 2,8-naphthalenedicarboxylic acid, 2,6-naphthalenedicarboxylic acid, etc.

Of those, more preferred as the aliphatic dicarboxylic acid are malonic acid, succinic acid, maleic acid, fumaric acid, glutaric acid, adipic acid, azelaic acid, and 1,4-cyclohexanedicarboxylic acid; and more preferred as the aromatic dicarboxylic acid are phthalic acid, terephthalic acid, isophthalic acid, 1,5-naphthalenedicarboxylic acid, and 1,4-naphthalenedicarboxylic acid. Even more preferred as the aliphatic dicarboxylic acid are succinic acid, glutaric acid, and adipic acid; and even more preferred as the aromatic dicarboxylic acid are phthalic acid, terephthalic acid, and isophthalic acid. Still more preferred are succinic acid and adipic acid.

Preferably, the aliphatic dicarboxylic acid for use in the invention has from 3 to 12 carbon atoms, more preferably from 3 to 8 carbon atoms. Also preferably, the aromatic dicarboxylic acid has from 8 to 14 carbon atoms, more preferably 8 carbon atoms.

Two or more different types of dicarboxylic acids may be used in the invention as a mixture thereof. In this case, preferably, the mean carbon number of the two or more different types of dicarboxylic acids is from 3 to 14, more preferably from 3 to 8.

When the carbon number of the dicarboxylic acid falls within the above range, then it is favorable since the polymer may be effective for reducing optical unevenness, may be excellent in miscibility with thermoplastic polymer, and may hardly bleed out during formation of polymer film and thermal stretching thereof.

Also preferred is combined use of aliphatic dicarboxylic acid and aromatic dicarboxylic acid. Concretely, preferred is combined use of adipic acid and phthalic acid, combined use of adipic acid and terephthalic acid, combined use of succinic acid and phthalic acid, or combined use of succinic acid and terephthalic acid; and more preferred is combined use of succinic acid and phthalic acid, or combined use of succinic acid and terephthalic acid. In case where aliphatic dicarboxylic acid and aromatic dicarboxylic acid are combined and used here, the blend ratio of the two (by mol) is preferably from 95/5 to 40/60, more preferably from 55/45 to 45/55.

Preferably, the diol (glycol) is selected from aliphatic diols having from 2 to 12 carbon atoms, alkyl ether diols having from 4 to 20 carbon atoms, and aromatic ring-containing diols having from 6 to 20 carbon atoms.

The aliphatic diol includes alkyl diols or alicyclic diols, for example, ethanediol (ethylene glycol), 3-oxapentane-1,5-diol (diethylene glycol), 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,4-hexanediol, 1,5-hexanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,4-cyclohexanediol, 1,4-cyclohexanedimethanol, etc. One or more of these glycols may be used here either singly or as combined as a mixture thereof.

As the aliphatic diol, preferred are ethanediol (hereinafter this may be referred to as ethylene glycol), 3-oxapentane-1,5-diol, 1,2-propanediol (hereinafter this may be referred to as propylene glycol), 1,3-propanediol, 1,2-butanediol, 1,3-butanediol, 2-methyl-1,3-propanediol, 1,4-butanediol, 1,5-pentanediol, 2,2-dimethyl-1,3-propanediol, 1,4-hexanediol, 1,5-hexanediol, 1,6-hexanediol, 2-methyl-1,8-octanediol, 1,4-cyclohexanediol, and 1,4-cyclohexanedimethanol; more preferred are ethanediol, 1,2-propanediol, 1,3-propanediol, 1,2-butanediol, 1,3-butanediol, 1,4-butanediol, 1,5-pentanediol, 1,6-hexanediol, 1,4-cyclohexanediol, and 1,4-cyclohexanedimethanol. Even more preferred are ethanediol and 1,2-propanediol.

As the alkyl ether diol having from 4 to 20 carbon atoms, preferred are polytetramethylene ether glycol, polyethylene ether glycol and polypropylene ether glycol, and their combination. Not specifically defined, the mean degree of polymerization of the diol is preferably from 2 to 20, more preferably from 2 to 10, even more preferably from 2 to 5, still more preferably from 2 to 4. As their examples, there may be mentioned typically-useful commercially-available polyether glycols, such as Carbowax Resin, Pluronics Resin and Niax Resin.

As the aromatic diol having from 6 to 20 carbon atoms, there may be mentioned with no limitation, bisphenol A, 1,2-hydroxybenzene, 1,3-hydroxybenzene, 1,4-hydroxybenzene, and benzene-1,4-methanol. Preferred are bisphenol A, 1,4-hydroxybenzene, and benzene-1,4-dimethanol.

Preferably, the aromatic diol has from 6 to 12 carbon atoms.

In case where two or more different types of diols are used here, preferably, the mean carbon number of those two or more types of diols is from 2 to 12.

When the carbon number of the diol falls within the above range, then it is favorable since the polymer may be effective for reducing optical unevenness, may be excellent in miscibility with thermoplastic polymer, and may hardly bleed out during formation of polymer film and thermal stretching thereof.

In the invention, also usable is a mixture of two or more different types of diols. In this case, preferably, the mean carbon number of those two or more types of diols is from 2 to 12, more preferably from 2 to 7.

Concretely, preferred is a combination of ethylene glycol and propylene glycol. In case where two or more different types of diols are used as a mixture thereof, the blend ratio of the two (by mol) is preferably from 95/5 to 5/95, more preferably from 55/45 to 45/55.

### Blocking)

Both terminals of the polyester oligomer in the invention may be either blocked or unblocked.

In case where both terminals of the polyester oligomer are unblocked, the oligomer is preferably a polyester polyol.

Also preferably, at least one terminal is blocked, and the terminal is at least one selected from an aliphatic group having from 1 to 22 carbon atoms, an aromatic ring-containing group having from 6 to 20 carbon atoms, an aliphatic carbonyl group having from 1 to 22 carbon atoms, and an aromatic carbonyl group having from 6 to 20 carbon atoms.

Further, in case where both terminals of the polyester oligomer are blocked, preferably, the oligomer is blocked through reaction with a monoalcohol or a monocarboxylic acid. In this case, both terminals of the oligomer are monoalcohol residues or monocarboxylic acid residues. In this, “residue” means a partial structure of the oligomer, and the partial structure characterizes the monomer that forms the oligomer. For example, the monocarboxylic acid residue of a monocarboxylic acid R—COOH is R—CO—.

The monoalcohol residue is preferably a substituted or unsubstituted monoalcohol residue having from 1 to 30 carbon atoms, including aliphatic alcohols such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tert-nonyl alcohol, decanol, dodecanol, dodecahexanol, dodecaoctanol, allyl alcohol, oleyl alcohol, etc.; substituted alcohols such as benzyl alcohol, 3-phenylpropanol, etc.

As the terminal-blocking alcohol residue preferred for use herein, there may be mentioned methanol, ethanol, propanol, isopropanol, butanol, isobutanol, isopentanol, hexanol, isohexanol, cyclohexyl alcohol, isooctanol, 2-ethylhexyl alcohol, isononyl alcohol, oleyl alcohol, benzyl alcohol; and more preferred are methanol, ethanol, propanol, isobutanol, cyclohexyl alcohol, 2-ethylhexyl alcohol, isononyl alcohol, benzyl alcohol.

The monocarboxylic acid residue is preferably an aliphatic monocarboxylic acid residue having from 2 to 22 carbon atoms, more preferably an aliphatic monocarboxylic acid residue having from 2 to 3 carbon atoms, even more preferably an aliphatic monocarboxylic acid residue having 2 carbon atoms.

When the carbon number of the monocarboxylic acid residue at both terminals of the polyester oligomer is at most 3, then the evaporability of the oligomer lowers and the loss on heating of the oligomer is not large, and the troubles of contamination in process and surface failure of film may be reduced. Accordingly, as the monocarboxylic acids for use for terminal blocking, preferred are aliphatic monocarboxylic acids. More preferred are aliphatic monocarboxylic acids having from 2 to carbon atoms, even more preferred are aliphatic monocarboxylic acids having from 2 to 3 carbon atoms, and still more preferred are aliphatic monocarboxylic acids having 2 carbon atoms.

As preferred aliphatic monocarboxylic acids, there may be mentioned acetic acid, propionic acid, butanoic acid, caprylic acid, caproic acid, decanoic acid, dodecanoic acid, stearic acid, oleic acid. As aromatic ring-containing monocarboxylic acids, there may be mentioned, for example, benzoic acid, p-tert-butylbenzoic acid, p-tert-amylbenzoic acid, orthotoluic acid, metatoluic acid, paratoluic acid, dimethylbenzoic acid, ethylbenzoic acid, normal-propylbenzoic acid, aminobenzoic acid, acetoxybenzoic acid, etc.

Of those, preferred are acetic acid, propionic acid, butanoic acid, benzoic acid and their derivatives; more preferred are acetic acid and propionic acid; and most preferred is acetic acid (to give an acetyl group at the terminal). Two or more different types of monocarboxylic acids may be combined and used for terminal blocking.

In case where both terminals are blocked, the polymer could hardly be solid at room temperature and its handlability may be better, and in addition, a polymer film excellent in moisture stability and polarizer durability may be obtained.

Preferably, the number-average molecular weight of the polycondensate ester is from 500 to 2000, more preferably from 600 to 1500, even more preferably from 700 to 1200. When the number-average molecular weight of the polycondensate ester is at least 600, then the evaporability thereof lowers and the troubles of film failure and contamination in process owing to vaporization under high-temperature condition in stretching cellulose ester film may be prevented. When the molecular weight is at most 2000, the miscibility of the polymer with cellulose ester may increase and the trouble of bleeding out in film formation or stretching under heat may be prevented.

Specific examples of the polycondensate esters usable in the invention are shown in the following Table 1 and Table 2, to which, however, the invention should not be limited. In the following Table 1 and Table 2, PA means phthalic acid, TPA means terephthalic acid, IPA means isophthalic acid, AA means adipic acid, SA means succinic acid, 2,6-NPA means 2,6-naphthalenedicarboxylic acid.

TABLE 1

| | Dicarboxylic Acid*¹⁾ | | | | Diol | | | | | Number- |
|---|---|---|---|---|---|---|---|---|---|---|
| | Aromatic | Aliphatic | Dicarboxylic | | | | Diol | | | Average |
| | Dicarboxylic | Dicarboxylic | Acid Ratio | Mean C | | | Ratio | Mean C | | Molecular |
| | Acid | Acid | (mol %) | Number | Diol 1 | Diol 2 | (mol %) | Number | Terminal | Weight |
| A-1 | TPA | SA | 45/55 | 5.00 | ethanediol | propanediol | 45/55 | 2.55 | acetyl ester residue | 750 |
| A-2 | TPA | SA | 50/50 | 6.00 | ethanediol | propanediol | 45/55 | 2.55 | acetyl ester residue | 750 |
| A-3 | TPA | SA | 55/45 | 6.20 | ethanediol | propanediol | 45/55 | 2.55 | acetyl ester residue | 750 |
| A-4 | TPA | SA | 65/35 | 6.60 | ethanediol | propanediol | 45/55 | 2.55 | acetyl ester residue | 750 |
| A-5 | TPA | SA | 55/45 | 6.20 | ethanediol | propanediol | 25/75 | 2.75 | acetyl ester residue | 800 |
| A-6 | TPA | SA | 55/45 | 6.20 | ethanediol | propanediol | 10/90 | 2.90 | acetyl ester residue | 800 |
| A-7 | 2,6-NPA | SA | 50/50 | 8.00 | ethanediol | propanediol | 45/55 | 2.55 | acetyl ester residue | 850 |
| A-8 | 2,6-NPA | AA | 50/50 | 9.00 | ethanediol | propanediol | 45/55 | 2.55 | acetyl ester residue | 850 |
| A-9 | TPA/PA | SA | 45/5/50 | 6.00 | ethanediol | propanediol | 45/55 | 2.55 | acetyl ester residue | 1500 |
| A-10 | TPA/PA | SA | 40/10/50 | 6.00 | ethanediol | propanediol | 45/55 | 2.55 | acetyl ester residue | 1200 |
| A-11 | TPA | SA/AA | 50/30/20 | 6.40 | ethanediol | propanediol | 45/55 | 2.55 | acetyl ester residue | 1200 |
| A-12 | TPA | SA/AA | 50/20/30 | 6.60 | ethanediol | propanediol | 45/55 | 2.55 | acetyl ester residue | 1000 |
| A-13 | TPA | AA | 50/50 | 7.00 | ethanediol | propanediol | 45/55 | 2.55 | acetyl ester residue | 750 |
| A-14 | TPA | SA | 55/45 | 6.20 | ethanediol | butanediol | 25/75 | 3.50 | acetyl ester residue | 1800 |
| A-15 | TPA | SA | 55/45 | 6.20 | ethanediol | cyclohexanedimethanol | 25/75 | 6.50 | acetyl ester residue | 850 |
| A-16 | TPA | SA | 45/55 | 5.80 | ethanediol | propanediol | 45/55 | 2.55 | hydroxyl group | 750 |
| A-17 | TPA | SA | 50/50 | 6.00 | ethanediol | propanediol | 45/55 | 2.55 | hydroxyl group | 750 |
| A-18 | TPA | SA | 55/45 | 6.20 | ethanediol | propanediol | 45/55 | 2.55 | hydroxyl group | 750 |
| A-19 | TPA | SA | 65/35 | 6.20 | ethanediol | propanediol | 45/55 | 2.55 | hydroxyl group | 750 |
| A-20 | TPA | SA | 55/45 | 6.20 | ethanediol | propanediol | 25/75 | 2.75 | hydroxyl group | 1800 |
| A-21 | TPA | SA | 55/45 | 6.20 | ethanediol | propanediol | 10/90 | 2.90 | hydroxyl group | 1200 |
| A-22 | 2,6-NPA | SA | 50/50 | 8.00 | ethanediol | propanediol | 25/75 | 2.75 | hydroxyl group | 1000 |
| A-23 | 2,6-NPA | AA | 50/50 | 9.00 | ethanediol | propanediol | 25/75 | 2.75 | hydroxyl group | 850 |
| A-24 | TPA/PA | SA | 45/5/50 | 6.00 | ethanediol | propanediol | 25/75 | 2.75 | hydroxyl group | 850 |
| A-25 | TPA/PA | SA | 40/10/50 | 6.00 | ethanediol | propanediol | 25/75 | 2.75 | hydroxyl group | 900 |
| A-26 | TPA | SA/AA | 50/30/20 | 6.40 | ethanediol | propanediol | 25/75 | 2.75 | hydroxyl group | 750 |
| A-27 | TPA | SA/AA | 50/20/30 | 6.60 | ethanediol | propanediol | 25/75 | 2.75 | hydroxyl group | 850 |
| A-28 | TPA | AA | 50/50 | 7.00 | ethanediol | propanediol | 25/75 | 2.75 | hydroxyl group | 900 |
| A-29 | TPA | SA | 55/45 | 6.20 | ethanediol | butandiol | 25/75 | 3.50 | hydroxyl group | 1800 |
| A-30 | TPA | SA | 55/45 | 6.20 | ethanediol | cyclohexanedimethanol | 25/75 | 6.50 | hydroxyl group | 850 |
| A-31 | TPA | SA | 55/45 | 6.20 | ethanediol | propanediol | 45/55 | 2.55 | propionyl ester | 750 |
| | | | | | | | | | residue | |
| B-1 | TPA | SA | 35/65 | 5.40 | ethanediol | propanediol | 45/55 | 2.55 | acetyl ester residue | 850 |
| B-2 | TPA | SA | 30/70 | 5.20 | ethanediol | propanediol | 45/55 | 2.55 | acetyl ester residue | 900 |
| B-3 | TPA | AA | 35/65 | 6.70 | ethanediol | propanediol | 45/55 | 2.55 | acetyl ester residue | 750 |
| B-4 | 2,6-NPA | SA | 50/50 | 8.00 | ethanediol | propanediol | 45/55 | 2.55 | acetyl ester residue | 850 |
| B-5 | 2,6-NPA | AA | 70/30 | 10.20 | ethanediol | propanediol | 45/55 | 2.55 | acetyl ester residue | 1200 |
| B-6 | TPA | SA | 55/45 | 6.20 | | butanediol | 100 | 4.00 | hydroxyl group | 900 |
| B-7 | TPA | SA | 55/45 | 6.20 | | cyclohexanedimethanol | 100 | 6.00 | hydroxyl group | 850 |
| B-8 | TPA | SA | 55/45 | 6.20 | ethanediol | | 100 | 2.00 | hydroxyl group | 750 |
| B-9 | TPA | SA | 55/45 | 6.20 | ethanediol | propanediol | 45/55 | 2.55 | hydroxyl group | 450 |
| B-10 | TPA | SA | 55/45 | 6.20 | ethanediol | propanediol | 45/55 | 2.55 | hydroxyl group | 2500 |

TABLE 2

| | Dicarboxylic Acid | | | | | | | Number- |
|---|---|---|---|---|---|---|---|---|
| | Aromatic | Aliphatic | Dicarboxylic | Diol | | | | Average |
| | Dicarboxylic | Dicarboxylic | Acid Ratio | | | Diol Ratio | | Molecular |
| | Acid | Acid | (mol %) | Diol 1 | Diol 2 | (mol %) | Terminal | Weight |
| A-41 | — | AA | 100 | ethylene glycol | propylene glycol | 50/50 | acetyl ester residue | 1000 |
| A-42 | TPA | SA | 50/50 | ethylene glycol | — | 100 | hydroxyl group | 700 |
| A-43 | — | AA | 100 | ethylene glycol | — | 100 | acetyl ester residue | 1000 |
| A-44 | — | AA | 100 | propylene glycol | — | 100 | acetyl ester residue | 1000 |
| A-45 | — | AA | 100 | ethylene glycol | — | 100 | hydroxyl group | 1000 |
| A-46 | — | SA | 100 | ethylene glycol | — | 100 | hydroxyl group | 1000 |
| A-47 | — | AA | 100 | ethylene glycol | — | 100 | acetyl ester residue | 1000 |
| A-48 | — | SA/AA | 50/50 | ethylene glycol | propylene glycol | 50/50 | hydroxyl group | 1000 |

The polycondensate ester for use in the invention can be easily produced according to any of a method of thermal melt condensation through polyesterification or interesterification of a diol and a dicarboxylic acid in an ordinary manner, or a method of interfacial condensation of a dicarboxylic acid chloride and a glycol. The polycondensate esters for use in the invention are described in detail in Koichi Murai, “Plasticizers, Theory and Application Thereof” (by Miyuski Shobo Publishing, First Edition, No. 1, published on Mar. 1, 1973). Materials described in JP-A 05-155809, 05-155810, 5-197073, 2006-259494, 07-330670, 2006-342227, 2007-003679 are usable here.

The content of the polycondensate ester in the cellulose ester layer in the film of the invention is preferably from 5 to 40% by mass relative to the amount of the cellulose ester therein, more preferably from 8 to 30% by mass, even more preferably from 10 to 25% by mass.

The content of the starting materials, aliphatic diol, dicarboxylic ester or diol ester that may be in the polycondensate used in the invention, in the cellulose ester layer is preferably less than 1% by mass, more preferably less than 0.5% by mass. The dicarboxylic ester includes dimethyl phthalate, di(hydroxyethyl)phthalate, dimethyl terephthalate, di(hydroxyethyl)terephthalate, di(hydroxyethyl)adipate, di(hydroxyethyl)succinate, etc. The diol ester includes ethylene diacetate, propylene diacetate, etc.

The type and the ratio of the residues, dicarboxylic acid residue, diol residue and monocarboxylic acid residue contained in the polycondensate ester for use in the invention may be determined and measured according to known methods through H-NMR. In general, heavy chloroform may be used as the solvent.

The number-average molecular weight of the polycondensate ester may be measured according to ordinary methods through GPC (gel permeation chromatography), in which, in general, polystyrene is used as the standard reference material.

### <<Acrylic Oligomer or Acrylic Resin>>

In the invention, any other acrylic oligomer or acrylic resin than the thermoplastic resin used as the main ingredient in the acrylic resin layer and the cellulose acylate layer may be added to the acrylic resin layer and the cellulose acetate layer as the plasticizer therein. The proportion of the acrylic oligomer or the acrylic resin to the acrylic resin or the cellulose acylate used in the acrylic resin layer or the cellulose acylate layer as the main ingredient therein is preferably from 2 to 140% by mass based on the acrylic resin or the cellulose acylate used in the acrylic resin layer or the cellulose acylate layer as the main ingredient therein, more preferably from 4 to 100% by mass, most preferably from 6 to 60% by mass. The molecular weight of the acrylic oligomer or the acrylic resin is preferably from 500 to 200,000, more preferably from 1,000 to 100,000, even more preferably from 1,200 to 50,000, especially more preferably from 1,200 to 10,000. When the molecular weight falls within the range, then the acrylic resin used as the main ingredient in the acrylic resin layer as well as the cellulose acylate layer could be excellent in transparency.

The composition of the acrylic oligomer or the acrylic resin to be used for the purpose preferably contains an aliphatic (meth)acrylate monomer, an aromatic ring-containing (meth)acrylate monomer or a cyclohexyl group-having (meth)acrylate monomer as the main ingredient thereof. The main ingredient means that the constitutive mass ratio of the ingredient is higher than that of the other copolymerizable components in the (co)polymer.

Preferably, the constitutive mass ratio is from 40 to 100% by mass, more preferably from 60 to 100% by mass, most preferably from 70 to 100% by mass.

The aliphatic (meth)acrylate monomer includes, for example, methyl acrylate, ethyl acrylate, (i-, n-)propyl acrylate, (n-, i-, s-, t-)butyl acrylate, (n-, i-, s-)pentyl acrylate, (n-, i-)hexyl acrylate, (n-, i-)heptyl acrylate, (n-, i-)octyl acrylate, (n-, i-)nonyl acrylate, (n-, i-)myristyl acrylate, (2-ethylhexyl)acrylate, (c-caprolactone) acrylate, (2-hydroxyethyl)acrylate, (2-hydroxypropyl)acrylate, (3-hydroxypropyl)acrylate, (4-hydroxypropyl)acrylate, (2-hydroxybutyl)acrylate, (2-methoxyethyl)acrylate, (2-ethoxyethyl)acrylate, etc.; as well as methacrylates corresponding to the above-mentioned acrylates. Above all, preferred are methyl methacrylate, ethyl methacrylate, (i-, n-)propyl methacrylate, (n-, i-, s-, t-)butyl methacrylate, methyl acrylate, ethyl acrylate.

The aromatic ring-having (meth)acrylate monomer includes, for example, phenyl acrylate, phenyl methacrylate, (2 or 4-chlorophenyl)acrylate, (2 or 4-chlorophenyl)methacrylate, (2, 3 or 4-ethoxycarbonylphenyl)acrylate, (2, 3 or 4-ethoxycarbonylphenyl)methacrylate, (o or m or p-tolyl)acrylate, (o or m or p-tolyl)methacrylate, benzyl acrylate, benzyl methacrylate, phenethyl acrylate, phenethyl methacrylate, (2-naphthyl)acrylate, etc. Preferred is use of benzyl acrylate, benzyl methacrylate, phenethyl acrylate, phenethyl methacrylate.

The cyclohexyl group-having (meth)acrylate monomer includes, for example, cyclohexyl acrylate, cyclohexyl methacrylate, (4-methylcyclohexyl)acrylate, (4-methylcyclohexyl)methacrylate, (4-ethylcyclohexyl)acrylate, (4-ethylcyclohexyl)methacrylate, etc. Preferred is use of cyclohexyl acrylate and cyclohexyl methacrylate.

As further copolymerizable components in addition to the above-mentioned monomers, there may be mentioned α,β-unsaturated acids such as acrylic acid, methacrylic acid, etc.; unsaturated bond-containing dicarboxylic acids such as maleic acid, fumaric acid, itaconic acid, etc.; aromatic vinyl compounds such as styrene, α-methylstyrene, etc.; α,β-unsaturated nitriles such as acrylonitrile, methacrylonitrile, etc.; maleic anhydride, maleimide, N-substituted maleimide, glutaric anhydride, etc. Either singly or as combined, one alone or two or more of these monomers may be used as the copolymerization component.

In producing acrylic oligomers or acrylic resins having a weight-average molecular weight of at most 10,000 through ordinary polymerization, it is difficult to control the molecular weight of the produced polymers. For producing the polymers having such a low molecular weight, there may be employed a method of using a peroxide polymerization initiator such as cumeme peroxide or t-butyl hydroperoxide; a method of using a larger amount of the polymerization initiator than usual; a method of using a chain transfer agent such as a mercapto compound, carbon tetrachloride or the like, in addition to the polymerization initiator; a method of using a polymerization terminator such as benzoquinone, dinitrobenzene or the like in addition to the polymerization initiator; a method of bulk polymerization using, as the polymerization catalyst, a compound having one thiol group and one secondary hydroxyl group or a combination of the compound and an organic metal compound as in JP-A 2000-128911 or 2000-344823, etc. Any of these methods is favorably employed in the invention; but the method described in the patent publications is more preferred.

As the low-molecular to oligomer compounds, for example, employable here are phosphates, carboxylates, polyol esters, etc.

Examples of the phosphates include triphenyl phosphate (TPP), tricresyl phosphate, cresyl diphenyl phosphate, octyl diphenyl phosphate, biphenyl diphenyl phosphate, trioctyl phosphate, tributyl phosphate, etc. Preferred are triphenyl phosphate, biphenyl diphenyl phosphate.

The carboxylates typically include phthalates and citrates. Examples of the phthalates include dimethyl phthalate, diethyl phthalate, dibutyl phthalate, dioctyl phthalate, diphenyl phthalate, diethylhexyl phthalate, etc. Examples of the citrates include triethyl O-acetylcitrate, tributyl O-acetylcitrate, acetyltriethyl citrate, acetyltributyl citrate, etc.

These preferred plasticizers are liquid at 25° C., except TPP (having a melting point of about 50° C.), and have a boiling point of not lower than 250° C.

Examples or the other carboxylates include butyl oleate, methylacetyl ricinoleate, dibutyl sebacate, various trimellitates, etc. Examples of the glycolates include triacetin, tributyrin, butylphthalylbutyl glycolate, ethylphthalylethyl glycolate, methylphthalylethyl glycolate, butylphthalylbutyl glycolate, methylphthalylmethyl glycolate, propylphthalylpropyl glycolate, butylphthalylbutyl glycolate, octylphthalyloctyl glycolate, etc.

Plasticizers described in JP-A 5-194788, 60-250053, 4-227941, 6-16869, 5-271471, 7-286068, 5-5047, 11-80381, 7-20317, 8-57879, 10-152568, 10-120824 are also preferably used here. These patent publications disclose not only examples of the plasticizers but also various methods of using them and characteristics of the plasticizers; and the disclosure may be favorably referred to in the present invention.

As plasticizers also favorably usable here are (di)pentaerythritol esters described in JP-A 11-124445; glycerol esters described in JP-A 11-246704; diglycerol esters described in JP-A 2000-63560; citrates described in JP-A 11-92574; substituted phenyl phosphates described in JP-A 11-90946; ester compounds having an aromatic ring and a cyclohexane ring described in JP-A 2003-165868, etc.

One alone or two or more of these plasticizers may be used here either singly or as combined. The amount of the plasticizer to be added may be generally from 2 to 120 parts by mass relative to 100 parts by mass of the thermoplastic resin contained in the dope, preferably from 2 to 70 parts by mass, more preferably from 2 to 30 parts by mass, even more preferably from 5 to 20 parts by mass. Using the same plasticizer in the two neighboring layers of the dopes (A) and (B) for use in the production method of the invention to be mentioned below is favorable from the viewpoint that the interface between the dopes in casting can be prevented from being disordered, the interfacial adhesiveness may be bettered and the curling resistance of the formed film may be bettered. Especially preferably, the dopes (A) and (b) contains the same plasticizer.

### (Other Additives)

Any other additive than the above-mentioned plasticizer may be added to the optical film of the invention.

Examples of the additives include UV absorbent, fluorosurfactant (its preferred amount is from 0.001 to 1% by mass relative to the thermoplastic resin), release agent (from 0.0001 to 1% by mass), antioxidant (from 0.0001 to 1% by mass), optical anisotropy regulator (from 0.01 to 10% by mass), IR absorbent (from 0.001 to 1% by mass), etc.

Preferably, the UV absorbent for use herein is excellent in the ability to absorb UV rays having a wavelength of at most 370 nm from the viewpoint of preventing the degradation of liquid crystal, and absorbs as little as possible the visible light having a wavelength of at least 400 nm from the viewpoint of securing good image display capability. More preferably, the UV absorbent has a transmittance at a wavelength of 370 nm of at most 20%, even more preferably at most 10%, still more preferably at most 5%. The UV absorbent of the type includes, for example, oxybenzophenone compounds, benzotriazole compounds, salicylate compounds, benzophenone compounds, cyanoacrylate compounds, nickel complex compounds, UV absorbent group-having polymer UV absorbent compounds such as those mentioned above, etc., to which, however, the invention should not be limited. Two or more different types of UV absorbents may be used here as combined.

The optical film of the invention may contain a trace of particles of an organic material, an inorganic material or their mixture, as dispersed therein within a range not detracting from the effect of the invention. In case where the particles are used for the purpose of enhancing the travelability of film in film formation (that is, as a mat agent), the particle size of the particles is preferably from 5 to 3000 nm, and the amount thereof is preferably at most 1% by mass.

The particles may be added for roughening the surface of the film or for making the film have internal light scatterability, and in such a case, the particle size of the particles is preferably from 1 to 20 μm, and the amount thereof is preferably from 2 to 30% bymass. Preferably, the difference in the refractive index between the particles and the polymer film of the invention is from 0 to 0.5; and for example, in case where particles of an inorganic material are used, they may include particles of silicon oxide, aluminium oxide, barium oxide, etc. Examples of the particles of an organic material include acrylic resin, divinylbenzene resin, benzoguanamine resin, styrene resin, melamine resin, acryl-styrene resin, polycarbonate resin, polyethylene resin, polyvinyl chloride resin, etc. In case where the particles act to impart optical diffusibility to the optical film, the haze value is, though not specifically defined, preferably so controlled to fall within a range within which the backscattering is not too much increased and the total light transmittance is not lowered too much. Concretely, the haze is preferably from 1 to 60%, more preferably from 3 to 50%.

<Lamination of Additional Layer onto Optical Film>

The optical film of the invention may additionally have, as formed thereon, a curable resin layer having a thickness of from 0.1 μm to 15 μm. In addition, any other optically-functional layer such as antistatic layer, high-refractivity layer, low-refractivity layer or the like may be further formed on the curable resin layer. As the case may be, the curable resin layer may serve also as an antistatic layer or a high-refractivity layer.

The curable resin layer is preferably formed through crosslinking reaction or polymerization reaction of an ionizing radiation-curable compound. For example, a coating composition that contains an ionizing radiation-curable polyfunctional monomer or polyfunctional oligomer may be applied onto the light-transmissive substrate, and the polyfunctional monomer or the polyfunctional oligomer may be crosslinked or polymerized to form the intended layer.

The functional group of the ionizing radiation-curable polyfunctional monomer or polyfunctional oligomer is preferably one capable of polymerizing with light, electron beams or radiations, more preferably a photopolymerizing functional group.

The photopolymerizing group includes unsaturated polymerizing functional groups such as (meth)acryloyl group, vinyl group, styryl group, allyl group, etc.; and above all, preferred is a (meth)acryloyl group.

The curable resin layer may contain any known additive such as leveling agent, antifouling agent, antistatic agent, refractive index-controlling inorganic filler, scattering particles, thixotropic agent, etc.

The strength of the optical film having the curable resin layer formed thereon is preferably at least H in a pencil hardness test, more preferably at least 2H.

### [Method for Producing Optical Film]

The method for producing the optical film of the invention (hereinafter this may be referred to as the production method of the invention) comprises a step of casting at least two types of dopes (A) and (B) each containing a thermoplastic resin and an organic solvent onto a casting substrate simultaneously or successively in the order of (A)-(B)-(A) from the casting substrate side, and a step of removing the organic solvent, wherein the dope (A) contains a cellulose acylate and the dope (B) contains an acrylic resin having a weight-average molecular weight of from 600,000 to 4,000,000.

### <Preparation of Dope>

Regarding the preparation of the solution (dope) of a thermoplastic resin for use in the optical film of the invention, the dissolution method includes a room temperature dissolution method, a cooling dissolution method or a high-temperature dissolution method, or a combination of any of these methods. Regarding these, methods for preparing cellulose acylate solution are described, for example, in JP-A 5-163301, 61-106628, 58-127737, 9-95544, 10-95854, 10-45950, 2000-53784, 11-322946, 11-322947, 2-276830, 2000-273239, 11-71463, 04-259511, 2000-273184, 11-323017, 11-302388, etc. The techniques of the dissolution methods for cellulose acylate in organic solvent disclosed in these are applicable to the thermoplastic resin in the invention. The details of the methods, especially the non-chlorine solvents for use therein are described in detail in the above-mentioned Disclosure Bulletin No. 2001-1745, pp. 22-25. The dope solution of thermoplastic resin is generally concentrated and filtered, which is also described in detail in Disclosure Bulletin No. 2001-1745, p. 25. In dissolution at high temperature, the system is at a temperature not lower than the boiling point of the organic solvent used in most cases, and in such a case, the system is kept under pressure.

### (Organic Solvent)

The organic solvent (this may be referred to as solvent) that dissolve the organic solvent to form the dope in the invention is described. Any known organic solvent may be used as the organic solvent, and, for example, preferred are those having a solubility parameter of from 17 to 22. The solubility parameter is described, for example, in J. Brandrup, E. H. et al., “Polymer Handbook (4th Edition)”, VII/671 to VII/714. There may be mentioned lower aliphatic hydrocarbon chlorides, lower aliphatic alcohols, ketones having from 3 to 12 carbon atoms, esters having from 3 to 12 carbon atoms, ethers having from 3 to 12 carbon atoms, aliphatic hydrocarbons having from 5 to 8 carbon atoms, aromatic hydrocarbons having from 6 to 12 carbon atoms, fluoroalcohols (e.g., compounds described in JP-A 8-143709, paragraph [0020], 11-60807, paragraph [0037]), etc.

The solvent may be used here singly, but preferred is use of a mixture of a good solvent and a poor solvent for securing good surface condition stability of the film. More preferably, the blend ratio of the good solvent and the poor solvent is such that the proportion of the good solvent is from 60 to 99% by mass and that of the poor solvent is from 40 to 1% by mass. In the invention, the good solvent means a solvent capable of dissolving the resin for use herein by itself; and the poor solvent means a solvent that could not swell or dissolve the resin by itself. The good solvent for use in the invention includes organic halogen compounds such as methylene chloride, etc.; and dioxolans. As the poor solvent for use in the invention, for example, preferred are methanol, ethanol, n-butanol, cyclohexane, etc.

Preferably, the proportion of the alcohol in the organic solvent to be contained in the dopes (A) and (B) is from 10 to 50% by mass of the entire organic solvent from the viewpoint of shortening the drying time on the support (casting substrate) after film formation to thereby rapidly peel off the formed film and dry it, more preferably from 15 to 30% by mass.

Further, in the organic solvent contained in the dope (A) and the dope (B), preferably, the proportion of methanol to the entire organic solvent is from 20 to 35% by mass from the viewpoint of bettering the co-cast interlayer adhesiveness and bettering the reworkability of the film. The reworkability as referred to herein means the property of film of such that, when a polarizer protective film is once stuck to a polarizing element to produce a polarizer and the polarizer is once stuck to the glass substrate of a liquid crystal cell, the polarizer can be well peeled off and can be again stuck to the glass substrate for the purpose of increasing the production yield in producing polarizers and liquid crystal display devices. The proportion of methanol to the entire organic solvent in the dope is more preferably from 21 to 35% by mass, even more preferably from 25 to 30% by mass.

Preferably, the material to form the optical film is dissolved in the organic solvent in a concentration of from 10 to 60% by mass, more preferably from 10 to 50% by mass. In case where a cellulose acylate resin is the main ingredient, it is preferably dissolved in an amount of from 10 to 30% by mass, more preferably from 13 to 27% by mass, even more preferably from 15 to 25% by mass. Regarding the method of controlling the concentration, the system may be so controlled as to have the desired concentration in the dissolution stage, or the system may be previously so prepared as to have a low concentration (for example, from 9 to 14% by mass) and then this may be concentrated to have the predetermined high concentration in the subsequent concentration step. Further, a solution of the material to form the light-transmissive substrate having a high concentration may be previously prepared, and various additives may be added thereto to thereby lower the concentration of the solution to a predetermined level.

### (Solid Concentration in Dope)

In the production method of the invention, the solid concentration in the dope (B) (the concentration of the component to be solid after drying the dope) may be suitably selected depending on the molecular weight of the component. For making the dope have a viscosity suitable for solution casting film formation, the solid concentration is preferably from 16 to 30% by mass. Heretofore, for the reason that the content of the organic solvent can be reduced and the drying time can be shortened, it has been considered that the solid concentration is preferably from 30 to 50%; however, in the invention, the inventors have found that the solid concentration falling within the above range is preferred from the viewpoint of attaining the effect of the invention. More preferably, the solid concentration in the dope (B) is from 16 to 30% by mass, even more preferably from 18 to 25% by mass.

In the production method of the invention, preferably, the solid concentration in both the dope (A) and the dope (B) is from 16 to 30% by mass each.

On the other hand, in the production method of the invention, for obtaining a film having a good surface condition in co-casting film formation, preferably, the solid concentration in the dope (B) is on the same level as that of the solid concentration in the dope (A). Preferably, the difference between the dope (B) and the dope (A) in the solid concentration therein is at most 10% by mass, more preferably at most 5% by mass.

In particular, even more preferably, the total concentration of the components to be solid after drying in the dope (B) is from 16 to 30% by mass, and the difference in the concentration between the dope (B) and the dope (A) is at most 10% by mass.

### (Complex Viscosity of Dope)

In the production method of the invention, preferably, the complex viscosity of the dope (A) and the dope (B) each is from 10 to 80 Pa·s. The complex viscosity falling within the range is favorable since the solution casting aptitude of the dope is further bettered. The complex viscosity of the dope in the invention is the viscosity thereof measured with a fluid shear rheometer.

More preferably, the complex viscosity is from 20 to 80 Pa·s, even more preferably from 25 to 70 Pa·s. The viscosity was measured as follows: One mL of the sample solution was put into a rheometer (CLS 500), and analyzed with Steel Cone having a diameter of 4 cm/2° (both by TA Instrumennts).

The sample solution was previously warmed until its temperature became constant at the measurement start temperature, and then the measurement was started. The temperature at the start of the test is not specifically defined so far as it is the casting temperature. Preferably, the temperature is from −5 to 70° C., more preferably from −5 to 35° C.

In the production method of the invention, the viscosity of the dope may differ between the surface layer and the core layer, and preferably, the viscosity of the surface layer is smaller than the viscosity of the core layer. However, the viscosity of the core layer may be smaller than the viscosity of the surface layer. In the production method of the invention, above all, it is desirable that the complex viscosity of the dope (A) and the dope (B) each is from 10 to 80 Pa·s and the complex viscosity of the dope (B) is larger than the complex viscosity of the dope (A) from the viewpoint of bettering the film surface condition after film formation.

### (Composition of Thermoplastic Resin of Dope)

Further, from the viewpoint of securing support releasability, interfacial adhesiveness and curling resistance of the formed film, preferably, the composition of the thermoplastic resin in the dopes (A) and (B) satisfies the following condition. The proportion of the cellulose acylate resin in the thermoplastic resin in the dope (A) is preferably from 50 to 100% by mass, more preferably from 70 to 100% by mass, most preferably from 80 to 100% by mass. The proportion of the acrylic resin in the thermoplastic resin in the dope (B) is preferably from 30 to 100% by mass, more preferably from 50 to 100% by mass, most preferably from 70 to 100% by mass.

### (Simultaneous or Successive Casting Step)

The production method of the invention includes a step of casting at least two types of dopes (A) and (B) each containing a thermoplastic resin and an organic solvent onto a casting substrate simultaneously or successively in the order of (A)-(B)-(A) from the casting substrate side.

In the production method for an optical film of the invention, preferably, at least two types of the dopes (A) and (B) are cast on the casting substrate in that order from the casting substrate side.

The dope is cast onto a drum and the solvent is evaporated away from it to form a film. Preferably, the drum surface is finished in a mirror state. The casting and drying modes in a solvent casting method are described in U.S. Pat. No. 2,336,310, 2,367,603, 2,492,078, 2,492,977, 2,492,978, 2,607,704, 2,739,069, 2,739,070; British Patent 640731, 736892; JP-B 45-4554, 49-5614; JP-A 60-176834, 60-203430, 62-115035.

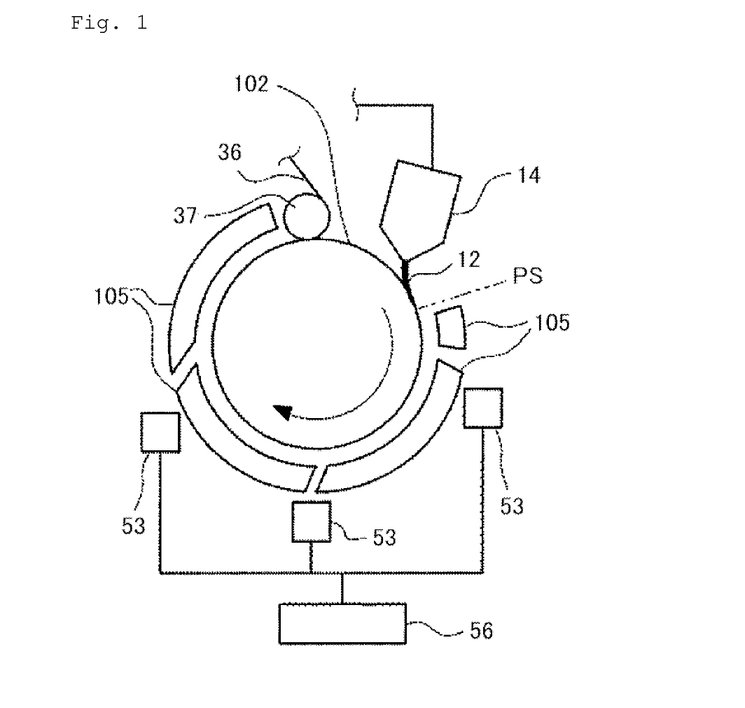

FIG. 1 is a view showing a casting apparatus having a drum. FIG. 1 is a schematic view showing the substantial part of the casting apparatus 101, and is a plane view taken from the side thereof. In FIG. 1, a drum 102 is used. The casting dope 12 from the casting die 14 is cast at a relatively lower position than the top of the drum 102, so that the cast film formed on the drum 102 could run downward from the casting start point PS. In this case, preferably, the casting start point PS is so positioned that the tangent line at the casting start point on the drum 102 could be identical as much as possible to the tangent line of the casting curve from the casting die 14.

The drum 102 has a temperature-controlling function. Outside the cast film, plural condenser plates 105 are arranged, and the condensed liquid runs along the inclination between the condenser plates 105 and is led into the external liquid receiver 53 and is then collected in the collector tank 56. The cast film running on the drum 102 is peeled by the peeling roller 37 to be a film 36, which is then fed to a drying zone in the next step. Accordingly, with preventing liquid dripping, the cast film can be uniformly dried and the solvent can be recovered at high yield. However, even when the rotating direction of the drum 102 is reversed and the running direction of the cast film is made upward from the casting start point PS, uniform drying of the cast film can be secured and the thickness of the film 36 can be kept uniform.

Preferably, the dope is cast onto the drum having a surface temperature of not higher than 5° C. The surface temperature of the casting substrate (drum) is preferably from −30 to 5° C., more preferably from −10 to 2° C.

Preferably, the cast film is dried by exposing it to air for at least 2 seconds after the casting. The formed film is peeled away from the drum, and may be dried at high-temperature air of which the temperature is successively changed from 100° C. to 160° C., to thereby evaporate the residual solvent. The method is described in JP-B 5-17844. According to the method, the time from casting to peeling may be shortened. For carrying out the method, the dope must gel at the surface temperature of the drum on which it is cast.

In the invention, at least the above-mentioned two types of dopes are cast on a casting substrate for film formation thereon. In the film production method of the invention, nothing is limited other than the above, and any known co-casting method is employable. For example, the dope solutions may be individually cast from plural casting mouths arranged in the metal support running direction at some intervals and laminated to form a film, and for example, the methods described in JP-A 61-158414, 1-122419, 11-198285 are employable. The film may also be formed by casting the dope solutions from two casting mouths, and for example, the methods described in JP-B60-27562, JP-A 61-94724, 61-947245, 61-104813, 61-158413, 6-134933 are employable.

In the production method of the invention, preferably, at least two types of the dopes (A) and (B) are simultaneously co-cast onto the casting substrate in order from the casting substrate side. More preferably, the dopes (A), (B) and (A) are simultaneously co-cast onto the support in that order from the support side. The compositions of the plural (A)'s in one laminate film may be completely the same or different.

In the case of co-casting, dope solutions in which the concentration of the additives such as the above-mentioned plasticizer, UV absorbent, mat agent or the like differs may be co-cast to form a laminate film. For example, the amount of the mat agent may be larger in the surface layer on the side of the support, or the mat agent may be only in the surface layer on the side of the support. The plasticizer and the UV absorbent may be in a larger amount in the core layer than in the surface layer, or may be only in the core layer. Between the core layer and the surface layer, the type of the plasticizer and the UV absorbent may be changed, and for example, low-volatile plasticizer and/or UV absorbent may be contained in the surface layer, and a plasticizer excellent in plasticization or a UV absorbent excellent in UV absorption may be added to the core layer.

### <Drying Step>

The production method of the invention includes a step of removing the organic solvent.

A method of drying the web that has been dried on the drum and has been peeled away is described. The web that has been peeled at the peeling position at which just before the drum goes into a 360-degree roll with the web thereon is then conveyed, according to a method of conveying it alternately through zigzag-arranged rolls, a method of contactlessly conveying the web while both sides of the web are held with clips or the like, etc. The web (film) may be dried according to a method of applying air at a predetermined temperature to both surfaces of the web being conveyed, or a method of heating the web with a heating means such as microwaves, etc. Too rapid drying is unfavorable as probably detracting from the surface planarity of the formed film. Accordingly, it is desirable that, in the initial stage of drying, the web is dried at a temperature at which the solvent does not foam, and after dried in some degree, the web is further dried at a high temperature. In the drying step after the film has been peeled away from the support, the film shrinks in the machine direction or in the cross direction owing to the solvent evaporation. The degree of shrinkage may be larger when the film is dried at a higher temperature. It is desirable that the film is dried while its shrinkage is retarded as much as possible, from the viewpoint of bettering the surface planarity of the formed film. From this viewpoint, for example, preferred is a method (tenter method) of drying the web while both sides of the web are held with clips or pins in the cross direction thereof so as to hold the width of the web in the entire drying step or partly in the drying step, as described in JP-A 62-46625. Preferably, the drying temperature in the drying step is from 100 to 145° C. The drying temperature, the drying air flow and the drying time may differ depending on the solvent to be used, and may be suitably selected in accordance with the type and the combination of the solvents to be used.

Preferably, after the multilayer-cast dopes have been dried, the formed film is peeled away from the support. The time to be taken after the dopes are cast on the casting substrate and before the formed film is peeled away, or that is, the time for which the film is conveyed on the casting substrate is at most 60 seconds, more preferably at most 30 seconds.

### <Stretching Step>

The production method of the invention may include a step of stretching the formed laminate film, after the film formation step. For example, in case where the film of the invention is desired to be further improved in point of the nonbrittleness thereof, the film may be stretched in a stretching step to reduce its brittleness. The improvement of the film in point of the nonbrittleness thereof may be confirmed, for example, according to the bending test of JIS P8115, in which the bending resistance of the film tested with an MIT tester is increased. In the test, the bending frequency before fracture is preferably at least one, more preferably at least 10, even more preferably at least 30.

In producing the film of the invention, preferably, the web (film) peeled from the support is stretched while the residual solvent content in the web is less than 120% by mass.

The residual solvent content may be represented by the following formula:

Residual Solvent Content(% by mass)={(M−N)/N}×100

wherein M means the mass of a web at a given point in time, and N means the mass of the web, of which M has been measured, after dried at 110° C. for 3 hours. In case where the residual solvent content in the web is too large, then the stretching would be ineffective; but when too small, the web may be extremely difficult to stretch and may be cut. A more preferred range of the residual solvent in the web is from 10% by mass to 50% by mass, most preferably from 12% by mass to 35% by mass. When the draw ratio in stretching is too low, the stretched film could not obtain sufficient retardation; but when too high, the web may be difficult to stretch and may be cut.

The draw ratio in stretching may be generally from 5% to 100%, preferably from 15% to 40%. Stretching in one direction by from 5% to 100% means that the distance between the clips or pins to hold the film is expanded in a range of from 1.05 to 2.00 times relative to the original distance therebetween before stretching.

The film may be stretched in the film traveling direction (machine direction) or in the direction perpendicular to the film traveling direction (cross direction), or in both directions.

In the invention, the film formed in a mode of solution casting film formation may be stretched even though not heated at a high temperature so far as the residual solvent content therein falls within a specific range; however, preferably, the film is stretched with drying as capable of shortening the stretching step. In the invention, preferably, the stretching temperature in the stretching step is from 110 to 190° C., more preferably from 120 to 150° C. The stretching temperature is preferably not lower than 120° C. from the viewpoint of securing low haze of the film, and is preferably not higher than 150° C. from the viewpoint of enhancing the optical performance expressibility thereof (from the viewpoint of thickness reduction of the film).

On the other hand, when the temperature of the web is too high, then the plasticizer therein may evaporate away; and therefore in case where a volatile low-molecular plasticizer is used therein, the temperature of the web is preferably within a range of room temperature (15° C.) to 145° C.

Stretching the film in biaxial directions perpendicular to each other is effective from the viewpoint of enhancing the optical performance expressibility of the film, especially from the viewpoint of increasing Rth (retardation) of the film.

In the invention, the film may be stretched simultaneously in biaxial directions in the stretching step, or may be stretched successively in biaxial directions. In the case where the film is stretched successively in biaxial directions, the stretching temperature may vary in every stretching in different directions.

In the case of simultaneous biaxial stretching, the film of the invention can be obtained even when stretched at a stretching temperature of from 110° C. to 190° C.; and the stretching temperature in simultaneous biaxial stretching is more preferably from 120° C. to 150° C., even more preferably from 130° C. to 150° C. Simultaneous biaxial stretching may increase the haze of the film in some degree, but can further enhance the optical performance expressibility of the film.

On the other hand, in the case of successive biaxial stretching, preferably, the film is first stretched in the direction parallel to the film traveling direction and then in the direction perpendicular to the film traveling direction. A more preferred range of the stretching temperature in successive stretching is the same as the preferred stretching temperature range for the above-mentioned simultaneous biaxial stretching.

### <Heat Treatment Step>

Preferably, the film production method of the invention includes a heat treatment step after the drying step. The heat treatment in the heat treatment step may be attained after the drying step, and the treatment may be attained just after the stretching/drying step, or may be attained in a different mode where the film is once wound up after the drying step and then heat-treated in an additional heat treatment step. In the invention, preferably, the heat treatment step is additionally provided after the drying step and after the film has been once cooled to room temperature to 100° C. or lower. This mode is advantageous in that a film having more excellent thermal dimension stability can be obtained. For the same reason, also preferably, the film is dried to have a residual solvent content of less than 2% by mass, more preferably less than 0.4% by mass just before the heat treatment step.

The heat treatment may be attained according to a method of applying air at a predetermined temperature to the film being conveyed, or a method of using a heating means such as microwaves, etc.

Preferably, the heat treatment is attained at a temperature of from 150 to 200° C., more preferably from 160 to 180° C. Also preferably, the heat treatment is attained for from 1 to 20 minutes, more preferably from 5 to 10 minutes.

### (Heated Water Vapor Treatment)

The stretched film may be thereafter processed in a step of applying thereto water vapor heated at 100° C. or higher. The water vapor applying step is preferred since, in the step, the residual stress of the produced optical film may be relaxed and the dimensional change thereof may be reduced. Not specifically defined, the temperature of the water vapor is 100° C. or higher; however, in consideration of the heat resistance of the film, the temperature of the water vapor may be at most 200° C.

### <Surface Treatment Step>

In case where the optical film of the invention is used as a protective film for polarizer and where the film is stuck to a polarizing element, preferably, the film is processed through acid treatment, alkali treatment, plasma treatment, corona treatment or the like for hydrophilicating the surface thereof, from the viewpoint of the adhesiveness of the film to the polarizing element.

### [Polarizer]

The optical film of the invention may be used in a polarizer having a polarizing element and, as arranged on at least one side thereof, a protective film, as the protective film therein.

Regarding the configuration of polarizer, in an embodiment where a protective film is arranged on both surfaces of the polarizing element therein, the optical film of the invention may be used as one protective film or the retardation film therein.

The polarizing element includes a iodine-based polarizing element, a dichroic dye-containing dye-based polarizing element and a polyene-type polarizing element. The iodine-based polarizing element and the dye-based polarizing element may be produced generally using a polyvinyl alcohol film.

As the polarizing element, herein usable is any known polarizing element, or a polarizing element cut out of a long-size polarizing element in which the absorption axis thereof is neither parallel nor vertical to the lengthwise direction thereof. The long-size polarizing element in which the absorption axis thereof is neither parallel nor vertical to the lengthwise direction thereof may be produced according to the following method.

Specifically, the polarizing element of the type may be produced according to a stretching method in which a polymer film such as polyvinyl alcohol film that is fed continuously is stretched while both sides thereof are held with a holding means and while tension is applied thereto, whereby the film is stretched by from 1.1 to 20.0 times in the film width direction, and in which, while the running speed difference in the machine direction in the holding unit to hold both sides of the film is kept at most 3%, the film traveling direction is folded with both sides of the film being kept held so that the angle between the film traveling direction at the outlet of the step of holding both sides of the film and the substantially stretching direction of the film could tilt by from 20 to 70°. In particular, in the method, the film is preferably tilted by 45° from the viewpoint of the producibility.

### [Liquid Crystal Display Device]

The optical film of the invention is favorably used in image display devices such as liquid crystal display devices (LCD), plasma display panels (PDP), electroluminescence displays (ELD), and cathode ray tube display devices (CRT).

The optical film of the invention and the polarizer of the invention can be advantageously used in image display devices such as liquid crystal display devices and others, and is favorably used therein as the outermost layer on the backlight side.

In general, a liquid crystal display device comprises a liquid crystal cell and two polarizers arranged on both sides of the cell, in which the liquid crystal cell carries liquid crystal between two electrode substrates. Further, one optically anisotropic layer may be arranged between the liquid crystal cell and one polarizer, or two optically anisotropic layers may be arranged between the liquid crystal cell and both polarizers in the device.

Preferably, the liquid crystal cell is a TN-mode, VA-mode, OCB-mode, IPS-mode or ECB-mode cell.

### EXAMPLES

The characteristics of the invention are described more concretely with reference to Examples given below.

In the following Examples, the material used, its amount and ratio, the details of the treatment and the treatment process may be suitably modified or changed. Accordingly, the invention should not be limitatively interpreted by the Examples given below.

Unless otherwise specifically indicated, “part” is by weight.

### [Measurement Methods]

### <Condition for Measurement of Weight-Average Molecular Weight>

The weight-average molecular weigh was measured through gel permeation chromatography. The condition for the measurement is as follows:

| | |
|---|---|
| Solvent | tetrahydrofuran |
| Apparatus | TOSOH HLC-8220GPC |
| Column | Three columns of TOSOH TSKgel |
| | Super HZM-H (4.6 mm × 15 cm) were |
| | connected. |
| Column temperature | 25° C. |
| Sample concentration | 0.1% by mass |
| Flow rate | 0.35 ml/min |
| Calibration curve | Calibration curves made with 7 |
| | samples of TOSOH's TSK standard polystyrene |
| | (Mw = 2800000 to 1050) were used. |

### <Film Surface Condition>

The maximum difference between the largest thickness and the smallest thickness (P-V value) of the film was determined, using a fringe analyzer, FUJINON FX-03. The test area was within a range of a circle having a diameter φ of 60 mm. The refractive index value inputted here was 1.48, the mean refractive index of cellulose acylate. The resolution of the apparatus was 512×512.

### (Humidity Dependence of Rth (ΔRth))

Regarding the change in the retardation value with humidity change, Rth (Rth(10%)) of the film was measured according to the same method as in this description except that the film was conditioned at 25° C. and at a relative humidity of 10% for 12 hours, Rth (Rth(80%)) of the film was measured according to the same method as in this description except that the film was conditioned at 25° C. and at a relative humidity of 80% for 12 hours, and the humidity dependence of Rth, ΔRth was computed from the found data. Concretely, ΔRth=Rth(10%)−Rth(80%); and the obtained results are shown in Table 3 below.

### (Photoelastic Coefficient)

A sample of 1 cm×5 cm was cut out of the formed optical film, and using a spectroscopic ellipsometer (JASCO's M-220), the in-plane retardation of the sample was measured with applying stress thereto at 25° C.; and from the retardation value and the inclination of the stress coefficient, the photoelastic coefficient was computed.

### Example 1

### Preparation of Dope

Dopes each having the composition shown in Table 3 below were prepared.

Acryl 1 to Acryl 5 are all polymethyl methacrylate; and their molecular weight is shown in Table 3 below.

Additive A1 is an acetate ester of a polycondensate of adipic acid/ethylene glycol propylene glycol (number-average molecular weight=1000, ethylene glycol/propylene glycol ratio=50/50).

Additive A2 is a condensate of terephthalic acid succinic acid/ethylene glycol (number-average molecular weight=700, terephthalic acid/succinic acid ratio=50/50).

Additive A3 is methyl acrylate (number-average molecular weight=1200).

TABLE 3

| | | | Degree of Substitution | | | | | | | | | |
|---|---|---|---|---|---|---|---|---|---|---|---|---|
| | | | of Cellulose Acylate | | | Additive | | Solvent Composition | | | | |
| | | weight- | | | total acyl | | amount | methylene | | | Dope Solid | |
| | | average | acetyl | propionyl | group | | added | chloride | methanol | butanol | Con- | Dope |
| Dope | Polymer | molecular | degree of | degree of | degree of | | [% by | [% by | [% by | [% by | centration | Viscosity |
| No. | type | weight | substitution | substitution | substitution | type | mass] | mass] | mass] | mass] | (% by mass) | [Pa · s] |
| AD1 | Acryl 1 | 1,500,000 | — | — | — | — | — | 79 | 20 | 1 | 20 | 40 |
| AD2 | Acryl 1 | 1,500,000 | — | — | — | — | — | 79 | 20 | 1 | 23 | 60 |
| AD3 | Acryl 1 | 1,500,000 | — | — | — | A-41 | 10 | 79 | 20 | 1 | 23 | 50 |
| AD4 | Acryl 2 | 670,000 | — | — | — | — | — | 79 | 20 | 1 | 20 | 6 |
| AD5 | Acryl 2 | 670,000 | — | — | — | — | — | 79 | 20 | 1 | 28 | 50 |
| AD6 | Acryl 3 | 350,000 | — | — | — | — | — | 79 | 20 | 1 | 24 | 3 |
| AD7 | Acryl 3 | 350,000 | — | — | — | — | — | 79 | 20 | 1 | 31 | 40 |
| AD8 | Acryl 4 | 2,800,000 | — | — | — | — | — | 79 | 20 | 1 | 16 | 40 |
| AD9 | Acryl 5 | 4,500,000 | — | — | — | — | — | 79 | 20 | 1 | 16 | — |
| AD10 | Acryl 1 | 1,500,000 | — | — | — | A-42 | 10 | 79 | 20 | 1 | 23 | 50 |
| AD11 | Acryl 1 | 1,500,000 | — | — | — | A-49 | 10 | 79 | 20 | 1 | 23 | 45 |
| AD12 | Acryl 1 | 1,500,000 | — | — | — | A-41 | 10 | 87 | 13 | 0 | 23 | 48 |
| AD13 | Acryl 1 | 1,500,000 | — | — | — | A-41 | 10 | 75 | 25 | 0 | 23 | 53 |
| AD14 | Acryl 1 | 1,500,000 | — | — | — | A-41 | 10 | 70 | 30 | 0 | 23 | 53 |
| TD1 | CA-1 | 200,000 | 2.9 | 0 | 2.9 | A-41 | 10 | 79 | 20 | 1 | 18 | 20 |
| TD2 | CA-2 | 200,000 | 2.4 | 0 | 2.4 | A-41 | 10 | 79 | 20 | 1 | 18 | 16 |
| TD3 | CA-3 | 200,000 | 0.18 | 2.47 | 2.65 | A-41 | 10 | 79 | 20 | 1 | 23 | 20 |
| TD4 | CA-1 | 200,000 | 2.9 | 0 | 2.9 | A-42 | 10 | 79 | 20 | 1 | 18 | 20 |
| TD5 | CA-1 | 200,000 | 2.9 | 0 | 2.9 | A-49 | 10 | 79 | 20 | 1 | 18 | 18 |
| TD6 | CA-1 | 200,000 | 2.9 | 0 | 2.9 | A-41 | 10 | 87 | 13 | 0 | 18 | 20 |
| TD7 | CA-1 | 200,000 | 2.9 | 0 | 2.9 | A-41 | 10 | 75 | 25 | 0 | 18 | 20 |
| TD8 | CA-1 | 200,000 | 2.9 | 0 | 2.9 | A-41 | 10 | 70 | 30 | 0 | 18 | 20 |

### <Condition for Film Formation>

The dopes shown in Table 3 were formed into a film in a mode of solution casting film formation, thereby producing an optical film having the configuration sown in Table 4 below. Concretely, through a three-layer co-casting Giesser, the dopes were co-cast onto a metal support to form thereon a film having the layer configuration as shown in Table 4. In this stage, the dopes were so cast as to form the layer 1, the layer 2 and the layer 3 in that order from the metal support surface side. The film thickness configuration is in terms of the thickness of each layer that was assumed to be a film having a uniform thickness, based on each dope flow rate. While on the metal support, the dope was dried with dry air at 40° C. to form a film thereon, then the film was peeled away, and with both sides of the film kept held with pins and with the distance between the pins kept constant, the film was dried with dry air at 105° C. for 5 minutes. After the pins were removed, the film was further dried at 130° C. for 20 minutes.

### <Production of Polarizer>

Each film produced in Examples and Comparative Examples and Fujitac TD60UL (by FUJIFILM) were dipped in an aqueous, 4.5 mol/L sodium hydroxide solution (saponification liquid) conditioned at 37° C., for 1 minute, then the films were washed with water, thereafter dipped in an aqueous 0.05 mol/L sulfuric acid solution for 30 seconds, and further led to pass through a water-washing bath. Using an air knife, the films were dewatered repeatedly three times to thereby remove water, and then kept in a drying zone at 70° C. for 15 seconds and thus dried, thereby producing saponified films.

According to Example 1 in JP-A 2001-141926, a film was stretched in the machine direction, between two pairs of nip rolls having a different peripheral speed to prepare a polarizing element having a thickness of 20 μm.

Thus obtained, the polarizing element was sandwiched between any two of the saponified films, and then stuck together using an adhesive of an aqueous 3% PVA (Kuraray's PVA-117H) solution in a roll-to-roll process in such a manner the polarization direction of the polarizing element could be perpendicular to the machine direction of the film, thereby producing a polarizer. In this, one film on the polarizing element is one selected from the saponified films shown in Table 4, and the other film thereon is the saponified Fujitac TD60UL.

In Comparative Example 3, the film readily peeled away from the polyvinyl alcohol, and therefore did not have a suitable workability for polarizer production. All the other films well adhered to polyvinyl alcohol, and therefore had excellent workability for polarizer production.

(Display Performance Evaluation in IPS-Mode Liquid crystal Display Device)

The polarizers set to sandwich the liquid crystal cell were peeled away from a commercially-available liquid crystal television (IPS-mode slim-type 42-inch liquid crystal television), and the previously produced polarizers were re-adhered to the liquid crystal cell using an adhesive, in such a manner that the film shown in Table 4 could face the liquid crystal cell side. Thus reconstructed, the liquid crystal television was kept in an environment at 50° C. and at a relative humidity of 80% for 3 days, and then transferred into an environment at 25° C. and at a relative humidity of 60%, in which the television was kept ON in a condition of black level of display, and after 48 hours, the panel was visually checked for the presence of absence of display unevenness. The evaluation results are shown in Table 4.

### (Front Direction Display Unevenness)

The panel was watched in the front direction of the device and visually checked for the brightness unevenness at the time of black level of display, and the device was evaluated according to the following evaluation standards.

A: Little display unevenness was seen in the environment at an illumination intensity of 100 lx.

B: Some but slight display unevenness was seen in the environment at an illumination intensity of 100 lx.

C: Definite display unevenness was seen in the environment at an illumination intensity of 100 lx.

D: Definite display unevenness was seen in the environment at an illumination intensity of 300 lx.

### (Oblique Direction Display Unevenness)

Further, the panel was checked for the brightness unevenness and color unevenness at the time of black level of display at an azimuth angle of 45 degrees and a polar angle of 70 degrees from the front direction, and the device was evaluated according to the following evaluation standards.

A: Little display unevenness was admitted in the environment at an illumination intensity of 100 lx.

B: Some but slight display unevenness was admitted in the environment at an illumination intensity of 100 lx.

C: Definite display unevenness was admitted in the environment at an illumination intensity of 100 lx.

D: Definite display unevenness was admitted in the environment at an illumination intensity of 300 lx.

### (Reworkability)

The produced polarizer of Examples and Comparative Examples was cut in the direction parallel to the absorption axis thereof to give apiece having a size of 4 cm square. Using an adhesive, Soken Chemical's SK-2057, the sample was stuck to a glass plate. The polarizer was peeled away in the 45-degree direction relative to the absorption axis thereof, and from the peeling degree between the polarizing element and the sample film, the sample was evaluated according to the following evaluation standards. The rank B and the rank A are on a level suitable to practical use.

A: No film remained on the glass plate.

B: The area of the film remained on the glass plate is at most ¼ of the adhered area.

C: The area of the film remained on the glass plate is from more than ¼ to ½ the adhered area.

D: The area of the film remained on the glass plate is more than ½ of the adhered area.

The evaluation results are shown in Table 4 below.

TABLE 4

| | | | | | | Maximum | | |
|---|---|---|---|---|---|---|---|---|
| | | | | | | Difference | | |
| | | | | | | between | | |
| | | | | Layer Thickness | Proportion | Largest | | |
| | | | | Configuration | of Cellulose | Thickness | | |
| | | | | [μm] | Acylate | and Smallest | | |
| | | | | (layer 1/ | Layer | Thickness | Re | Rth |
| | Layer 1 | Layer 2 | Layer 3 | layer 2/layer 3) | [%] | [μm] | [nm] | [nm] |
| Example 1 | TD1 | AD1 | TD1 | 3/45/3 | 12 | 0.6 | 0.1 | 1 |
| Example 2 | TD1 | AD2 | TD1 | 3/45/3 | 12 | 0.6 | 0.1 | 1 |
| Example 3 | TD1 | AD3 | TD1 | 3/45/3 | 12 | 0.6 | 0.1 | 1 |
| Example 4 | TD1 | AD3 | TD1 | 2/36/2 | 10 | 0.4 | 0.1 | 0 |
| Example 5 | TD1 | AD3 | TD1 | 10/40/10 | 33 | 0.8 | 0.3 | 5 |
| Example 6 | TD1 | AD3 | TD1 | 15/30/15 | 50 | 0.8 | 0.5 | 8 |
| Example 7 | TD1 | AD4 | TD1 | 3/45/3 | 12 | 1.6 | 0.1 | 1 |
| Example 8 | TD1 | AD5 | TD1 | 3/45/3 | 12 | 1.2 | 0.1 | 1 |
| Example 9 | TD1 | AD8 | TD1 | 3/45/3 | 12 | 0.8 | 0.1 | 1 |
| Example 10 | TD2 | AD3 | TD2 | 3/45/3 | 12 | 0.8 | 0.1 | 3 |
| Example 11 | TD3 | AD3 | TD3 | 3/45/3 | 12 | 0.6 | 0.1 | 1 |
| Example 12 | TD4 | AD10 | TD4 | 3/45/3 | 12 | 0.5 | 0.1 | 20 |
| Example 13 | TD5 | AD11 | TD5 | 3/45/3 | 12 | 0.8 | 0.1 | 2 |
| Example 14 | TD6 | AD12 | TD6 | 3/45/3 | 12 | 0.6 | 0.1 | 1 |
| Example 15 | TD7 | AD13 | TD7 | 3/45/3 | 12 | 0.6 | 0.1 | 1 |
| Example 16 | TD8 | AD14 | TD8 | 3/45/3 | 12 | 0.6 | 0.1 | 1 |
| Comparative | TD1 | AD6 | TD1 | 3/45/3 | 12 | 5.0 | 0.1 | 1 |
| Example 1 | | | | | | | | |
| Comparative | TD1 | AD7 | TD1 | 3/45/3 | 12 | 4.0 | 0.1 | 1 |
| Example 2 | | | | | | | | |
| Comparative | — | AD3 | — | 0/50/0 | 0 | 0.4 | 0.0 | −1 |
| Example 3 | | | | | | | | |
| Comparative | — | TD1 | — | 0/60/0 | 100 | 0.5 | 1.0 | 5 |
| Example 4 | | | | | | | | |

| | | Photoelastic | Front | Oblique | |
|---|---|---|---|---|---|
| | ΔRth | Coefficient | Direction | Direction | |
| | (10%-80%) | (×10⁻¹²) | Display | Display | |
| | [nm] | [Pa⁻¹] | Unevenness | Unevenness | Reworkability |
| Example 1 | 3 | −1 | A | B | B |
| Example 2 | 3 | −1 | A | B | B |
| Example 3 | 3 | −1 | A | B | B |
| Example 4 | 2 | −2 | A | A | B |
| Example 5 | 8 | 4 | B | C | B |
| Example 6 | 13 | 7 | C | C | B |
| Example 7 | 3 | −1 | B | B | C |
| Example 8 | 3 | −1 | B | B | C |
| Example 9 | 3 | −1 | A | B | C |
| Example 10 | 4 | 2 | B | B | C |
| Example 11 | 2 | −1 | A | B | A |
| Example 12 | 3 | 2 | A | C | B |
| Example 13 | 3 | −1 | A | B | B |
| Example 14 | 3 | −1 | A | B | C |
| Example 15 | 3 | −1 | A | B | A |
| Example 16 | 3 | −1 | A | B | A |
| Comparative | 3 | −1 | D | D | D |
| Example 1 | | | | | |
| Comparative | 3 | −1 | D | D | D |
| Example 2 | | | | | |
| Comparative | 0 | −4 | — | — | — |
| Example 3 | | | | | |
| Comparative | 21 | 10 | D | D | A |
| Example 4 | | | | | |

From the above, it is known that the films of the invention are all free from the problem of display unevenness to occur when the other parts in a liquid crystal display device are kept in contact with the cellulose ester film moiety thereof, and can be readily stuck to a polarizing element, and have a good film surface condition. Further, it is known that the films of Examples 11, 15 and 16 are especially excellent in reworkability.

Regarding the dope AD9 not satisfying the range of the production method of the invention, the ingredients could not well dissolve, and therefore the dope was not tested for measurement of the solution viscosity and was not used for film formation.

While the present invention has been described in detail and with reference to specific embodiments thereof, it will be apparent to one skilled in the art that various changes and modifications can be made therein without departing from the spirit and scope thereof.

The present disclosure relates to the subject matter contained in International Application No. PCT/JP2011/073025, filed Sep. 29, 2011; Japanese Patent Application No. 2010-219612 filed on Sep. 29, 2010; and Japanese Patent Application No. 2011-146320 filed on Jun. 30, 2011, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims.

What is claimed is:

1. An optical film having an acrylic resin layer containing an acrylic resin, and, as formed on the surface of the acrylic resin layer, at least one cellulose acylate layer containing a cellulose acylate, wherein the weight-average molecular weight of the acrylic resin used as the main ingredient in the acrylic resin layer is from 600,000 to 4,000,000.

2. The optical film according to claim 1, wherein the weight-average molecular weight of the cellulose acylate used as the main ingredient in the cellulose acylate layer is from 50,000 to 500,000.

3. The optical film according to claim 1, wherein the thickness of the acrylic resin layer is from 20 to 60 μm, and the thickness of every cellulose acylate layer is from 1 to 10 μm.

4. The optical film according to claim 1, wherein the proportion of the total thickness of the cellulose acylate layer to the overall film thickness is at most 40%.

5. The optical film according to claim 1, wherein the degree of substitution with the acyl group in the cellulose acylate is from 1.2 to 3.0.

6. The optical film according to claim 1, wherein the weight-average molecular weight of the acrylic resin used as the main ingredient in the acrylic resin layer is from 1,000,000 to 1,800,000.

7. The optical film according to claim 1, which has a photoelastic coefficient of from −5.0 to 5.0×10⁻¹² Pa⁻¹.

8. The optical film according to claim 1, wherein the in-plane retardation, Re, defined by the following formula (I) and the thickness-direction retardation, Rth, defined by the following formula (II) satisfy the following formula (III) and the following formula (IV) in an environment at 25° C. and at a relative humidity of 60%, and wherein the absolute value of the difference between the value Rth measured in an environment at 25° C. and at a relative humidity of 10% and the value Rth measured in an environment at 25° C. and at a relative humidity of 80% is at most 10 nm:
Re=(nx−ny)×d (I)
Rth={(nx+ny)/2−nz}×d (II)

|Re|<10 nm (III)

|Rth|<25 nm (IV)
wherein nx means the in-plane refractive index of the film in the slow axis direction; ny means the in-plane refractive index of the film in the fast axis direction; nz means the refractive index of the film in the thickness direction; d means the film thickness (nm).

9. The optical film according to claim 1, wherein the cellulose acylate layer is provided on both surfaces of the acrylic resin layer.

10. A method for producing an optical film comprising:
casting at least two types of dopes (A) and (B) each containing a thermoplastic resin and an organic solvent onto a casting substrate simultaneously or successively in the order of (A)-(B)-(A) from the casting substrate side, and
removing the organic solvent,
wherein the dope (A) contains a cellulose acylate and the dope (B) contains an acrylic resin having a weight-average molecular weight of from 600,000 to 4,000,000.

11. The method for producing an optical film according to claim 10, wherein the weight-average molecular weight of the cellulose acylate contained in the dope (A) is from 50,000 to 500,000.

12. The method for producing an optical film according to claim 10, wherein the solid concentration of the dope (A) and the dope (B) each is from 16 to 30% by mass.

13. The method for producing an optical film according to claim 10, wherein the absolute value of the difference between the solid concentration of the dope (A) and that of the dope (B) is at most 10% by mass.

14. The method for producing an optical film according to claim 10, wherein the complex viscosity of the dope (A) and the dope (B) each is from 10 to 80 Pa·s and the complex viscosity of the dope (B) is larger than the complex viscosity of the dope (A).

15. The method for producing an optical film according to claim 10, wherein in the organic solvent contained in the dope (A) and the dope (B), the proportion of methanol to the entire organic solvent in the dope is from 20 to 35% by mass.

16. An optical film produced by casting at least two types of dopes (A) and (B) each containing a thermoplastic resin and an organic solvent onto a casting substrate simultaneously or successively in the order of (A)-(B)-(A) from the casting substrate side, and removing the organic solvent, wherein the dope (A) contains a cellulose acylate and the dope (B) contains an acrylic resin having a weight-average molecular weight of from 600,000 to 4,000,000.

17. A polarizer containing a polarizing element and an optical film, wherein the optical film has an acrylic resin layer containing an acrylic resin, and, as formed on the surface of the acrylic resin layer, at least one cellulose acylate layer containing a cellulose acylate, wherein the weight-average molecular weight of the acrylic resin used as the main ingredient in the acrylic resin layer is from 600,000 to 4,000,000.

18. A liquid crystal display device containing an optical film wherein the optical film has an acrylic resin layer containing an acrylic resin, and, as formed on the surface of the acrylic resin layer, at least one cellulose acylate layer containing a cellulose acylate, wherein the weight-average molecular weight of the acrylic resin used as the main ingredient in the acrylic resin layer is from 600,000 to 4,000,000.
